(19) United States
(12) Patent Application Publication
(10) Pub. No.: US 2002/0111922 A1
(43) Pub. Date: Aug. 15, 2002

(54) Electronic markets business interchange system and method

(75) Inventors: Terry Bernard Young, Asbury, NJ (US); Richard Allen Yoder, Lebanon, NJ (US)

Correspondence Address: John F. Letchford, Klehr, Harrison, Harvey, Branzburg & Ellers, 260 South Broad Street, Philadelphia, PA, 19102, US

(73) Assignee: Terry Bernard Young

(21) Appl. No.: 10/012,674

(22) Filed: Nov. 5, 2001

Related U.S. Application Data
(60) Provisional application No. 60/246,040, filed on Nov. 6, 2000.

(51) Int. Cl. G06F 17/60

(52) U.S. Cl. 705/80

(57) ABSTRACT

A method and system to enable, streamline, and enhance the cross-organizational processes of contract management. The system includes a contract management module and an interface module. The contract management module has functional dimensions that enable contract creation, negotiation, collaboration, approval, analytics and storage. The contract management module is preferably a Java based, n-tier, object-orientated solution that is configurable and scalable. The interface module provides the interfaces, communication methods, common protocols and formats to integrate multiple back-end systems, applications, electronic markets and other installations using contract management module together in a virtual network.

### CROSS-REFERENCE TO RELATED APPLICATION(S)

This application claims the benefit of U.S. Provisional Application No. 60/246,040, filed Nov. 6, 2000.

### FIELD OF THE INVENTION

The present invention relates to in general to systems and methods for supporting transactions and collaboration between companies and, more particularly, to systems and methods for supporting contract management and integration with multiple systems consisting of various architectures.

### BACKGROUND OF THE INVENTION

Contracts can range from being simple to extremely complex and often require significant time and resources from each company, agency or other party involved to ensure that the contract is executed in a timely and effective manner. Several factors contribute to the complexity level of a contract including: the type of contract (e.g., commercial, government, distributor), size of the business (e.g., length of term, financial complexity, multi-party approval process), industry (e.g., audit requirements, federal regulations), and type of product/service that is being delivered. For example, government, pharmaceutical, and engineering/construction agreements tend to be less standardized and highly complex whereas insurance agreements tend to be more standardized and less complicated. Although the advent of the Internet has helped to enhance the information transfer speed between the contracting parties, the contract management process has remained primarily a manual and disjointed process.

For complex contracts, the manual contracting process may be a highly interactive and lengthy process between the contractor and the party seeking goods/services from the contractor. Much of the delay is caused by the serial nature of the process and the challenges of exchanging information within and between the parties via postal services, electronic mail, facsimile, telephone or other communications systems. The manual process produces a final contract in hard copy that usually must be re-keyed into each organization's back-end systems. This manual process does not enable detailed collaboration and negotiation to occur in a common workspace. It also does not provide visibility of the entire process by all participating parties. And, it does not make available any mechanisms or tools to effectively manage the approval process or provide real-time process metrics to analyze and enhance the process.

Another significant challenge is being able to efficiently collect up-to-date and pertinent information, which typically resides in several disparate computer systems across organizations, that is necessary to generate the proposal and negotiate the contract. In addition, it is difficult to maintain a comprehensive history and record of documentation which is readily accessible and that reflects the decisions that were made in regard to a specific contract. Emails, faxes and other associated documents are usually scattered among the personal computers of many individuals involved. Therefore, there is little if any integrated and reliable visibility of the status of the contract or the associated proposal across either organization throughout the process, thereby commonly resulting in significant document version control issues. These problems are exacerbated when more than two contractors, agencies, organizations or other parties participate in the contract.

The ability to easily and securely transfer information among organizations has been an historic problem for businesses. Before the emergence of the Internet, large businesses spent significant monies and resources to establish private networks with specifically selected business partners. Electronic Data Interchange (EDI) is an example of one of these networks. EDI resulted in a reliable mechanism to exchange pre-determined information formats with another organization. However, it required considerable startup and maintenance costs and it did not provide any flexibility on what or how the information was communicated. As a result, each participant had to comply with the pre-determined formats and application interfaces and each participant had to commit substantial resources to successfully establish and maintain an EDI network.

Email systems and intranets have become common among businesses and this has created a greater focus on the integration of internal applications to provide access to an organization's information assets. For example, for the asynchronous exchange of information between mainframes in a corporate network, Message-Oriented Middleware (MOM) has become prevalent in providing a mechanism to reliably delivery data while allowing the systems to be loosely coupled, i.e., not always operating at the same speed, sometimes disconnected, and not having the recipient synchronously lock until the communication was completed. MOMs coordinate message traffic between distributed applications and handle network communications so that application developers do not have to focus on the underlying transport system. Although MOMs have been broadly accepted for internal application integration projects, the limitation of any MOM is that it provides the plumbing to connect various system together but lacks context in the form of the standards, business rules, predefined events for processing object-contextual actions, and object definitions that allows various applications to have meaningful communication across enterprises.

The foregoing approaches do not provide the necessary systems, methods, mechanisms, or tools to efficiently and effectively manage complex contracts or to provide secure and flexible communications and transactions across multiple organizations. Effective contract management is essential since most products and services are purchased on a contractual basis. It has been estimated that the average Fortune 1000 company participates a range of between 20,000 and 40,000 total contracts annually.

U.S. Pat. No. 6,067,531, is entitled “Automated Contract Negotiator/Generation System and Method” and discloses a system for automating negotiation and generation of contract documents. The system described therein utilizes applets to enforce business logic and workflow. An applet is essentially a client-server application where the client is downloaded from a web site instead of being installed at each users workstation. These types of applications are typically referred to as “thick” clients since both the presentation and business logic is downloaded to the clients for execution. This is different then web based “thin” clients that only send the presentation logic to the client and execute the business logic on the server. The main disadvantages of thick clients are: decreased portability and slower load times. Furthermore, releasing new versions of the business logic is more difficult as all clients need to be updated.

The system described in U.S. Pat. No. 6,067,531 also utilizes a client-server component architecture which requires installation on the user's client computer and limits flexibility.

Another shortcoming of such a system is that in order to provide a customer with an executable copy of the contract, the current contract version must be printed out in hard copy and sent to them. Thus, the contract development process is punctuated by a series of printing and sending steps which tend to prolong contract completion.

The system described in U.S. Pat. No. 6,067,531 is also focused on only one internal approval process flow. By supporting only the internal approval process flow, it does not facilitate a cross-organization contract management process. As a result, it is focused on the internal development of simple contracts as opposed to multi-party cross-organizational development of complex contracts. It does not enable the combined cross-organizational processes that result from contributions from each of the individual participating organizations processes. It is intended to reside within an organization and to be utilized by that one organization, i.e., it is not utilized by several organizations as a collaboration tool during the contract management process.

Additionally, the system in U.S. Pat. No. 6,067,531 addresses only the language of simple contracts and does not support the import of large amounts of complex information (e.g., bills of material). As such, its utility in complex contract negotiation and development is somewhat limited. Moreover, it only works internal to a business to automate the contract negotiation and generation process with the assistance from a graphical user interface (GUI). That is, it does not facilitate processes that span across organizations nor does it enables more than just two organizations to collaborate during the contract management process.

In addition, the system is focused on providing standard legal language that is re-usable. Consequently, it does support extensive proposals and other potentially complex supporting documentation. It also does not provide the ability to control the visibility of the information. That is, if the information is in the system, then it is available to all subscribers and there is no ability to control which subscribers can view the information.

Other disadvantages include its inability to offer event processing, event driven communication, real-time metrics, calculation of cycle times, and analytics. It also does not support the ability to attach documents of any format (Word, JPEG, Project Plan) to any object in the system.

U.S. Pat. No. 6,141,653 is entitled “System for Iterative, Multivariate Negotiations over a Network” and describes a system for enabling a sponsor to create a web based buying and selling community for buyers and sellers having similar interests. The system allows sponsors to create “interested community” websites and provides templates for doing so and does not create websites for general access. In the system, the sponsor is the “middle-man” and controls the interaction between all participants. Using such a system, therefore, users cannot collaborate independently with each other without interference from a central clearinghouse. Having no need for direct subscriber interaction the system does not provide collaboration tools that promote collaboration through enabling action items, issue items, notes, and attachments to be attached to any object in the system.

The system provided in U.S. Pat. No. 6,141,653 also has a simplistic user log-on password and access control. It does not offer a configurable permission model based on each object and it does not utilize Roles to assign specific permissions to groups of users. The system is further focused on the terms and conditions of a simple contract and does not support the import of large amounts of complex information (e.g., bills of material).

The system does not support a multi-step approval process and it does not facilitate a cross-organization process flow. And, like the system described in U.S. Pat. No. 6,067,531, it does not offer event processing, event driven communication, real-time metrics, calculation of cycle times, and analytics. It also does not support the ability to attach documents of any format (Word, JPEG, Project Plan) to any object in the system.

U.S. Pat. No. 5,794,053 is entitled “Method And System For Dynamic Interface Contract Creation” and describes a system for creating user-defined interface contracts for sending host system data to an external system. The invocation of a contract is controlled by a set of user defined conditions known as an event. The creation of event and contracts is completely under the control of the users of the external systems with little or no support of the host system developers to establish new interfaces to the external systems.

Among the disadvantages of such a system is that the user must name all fields that are to be transferred and it is not based on any universal standards or naming, Indeed, it uses different names for similar fields. It is not a collaborative environment: it just pushes information from the host system to other connected systems. Since it does not support collaboration it likewise does not support the facilitation of a cross-enterprise contracting process.

It also does not increase visibility of the overall contracting process as the process as it unfolds. Its focus is toward the situation where many external systems require the same data from one host system. Consequently, it is directed to transferring data from one system to another based on certain conditions and does not support the creation of a complex multi-part contract with input from multiple systems.

In addition, it is founded on a serial rather than a parallel process, i.e., the host does something and passes data, the target does something and passes data, etc. It does not perform multiple operations at the same time. The host system and external system are hub-like in arrangement (i.e., a host-to-child(ren) model) and function less like atomic units (nodes) that work independently of others. It also does not support a multi-step approval process.

The system disclosed in U.S. Pat. No. 5,794,053 is focused on exchanging a subset of data fields that are related and that are to be transmitted from the host system to a remote system upon the occurrence of a set of conditions (defined therein as an “Interface Contract”). It does not facilitate the creation, negotiation, collaboration of a “Contract” as per the standard definition or conventional sense thereof.

It also does not offer real-time metrics, calculation of cycle times, and analytics; nor does it support the ability to attach documents or other attachments of any format to any object in the system.

U.S. Pat. No. 5,794,053 utilizes the term “Event Processor” in reference to events defined by the user that cause the host system to format data and transmit the data to an external system. The event processor does not employ configurable business logic that determines what actions (automated notification, broadcasting information to multiple different applications, etc.) should occur based on events.

U.S. Pat. No. 5,903,891 is entitled “Hierarchical Information Processes That Share Intermediate Data and Formulate Contract Data” and describes an information system that enables differing information processes of extended duration to share intermediate data prior to their completion without sacrificing data integrity controls. The information system includes a contract process that is a parent of the information processes. The contract process obtains a set of data updates from one of the child transactions of each of the processes prior to completion of the processes. The contract process generates a set of contract data based upon the data updates obtained from the processes and holds the contract data until successful completion of the processes.

The system disclosed therein is a point-to-point solution and does not offer collaborative tools. Hence, it does not support full collaboration ability on the data in the central process. For example, it does not enable collaborative tools such as action items, issue items, notes, and attachments to be attached to any object in the system. It also does not offer event processing or event-driven communication.

Additionally, the system described in U.S. Pat. No. 5,903,891 does not support a flexible cross-organizational approval process and does not provide a specific function that supports the contract workflow. And, it also does not offer real-time metrics, calculation of cycle times, and analytics; nor does it support the ability to attach documents or other attachments of any format to any object in the system.

U.S. Pat. No. 6,236,984 is entitled “Method and System of Managing Contract Negotiation Records” and describes a method and system of managing contract negotiation records. The system comprises a contract table, a plurality of activity tables and a contract interface. The contract table may comprise a plurality of contract records each having a plurality of fields of contract data and a unique contract identifier. The activity tables may each comprise a plurality of activity records associated with one of the contract records to form a contract negotiation record. Each of the activity records may have a plurality of fields of activity data. The contract interface may be displayed as a series of graphical displays providing selections for manipulating at least one of the contract negotiation records. A selection to manipulate a contract negotiation record may be received via the contract interface and automatically processed.

Significantly, the invention disclosed in U.S. Pat. No. 6,236,984 is directed toward contract data storage, not collaboration. It does not enable collaborative tools such as action items, issue items, notes, and attachments to be attached to any object in the system. It also does not offer event processing or event-driven communication. It discloses no approval process or the notion of controlling what information is visible to participants in the system. And, it does not support integration with other applications and or support real-time metrics.

A need exists, therefore, for a web based contract management system which enables efficient creation, negotiation, and collaboration of complex contracts.

A further need exists for a contract management system which provides for the utilization of information assets via integration with multiple systems, cross-organizational approval processes, and real-time contract analytics. Moreover, a need exists for a contract management system which streamlines and rationalizes cross-organizational business processes and that integrates with multiple applications, thereby enabling the controlled use of secured data without the use of proprietary or private networks.

### SUMMARY OF THE INVENTION

The invention disclosed herein provides a method and system to enable, streamline, and enhance the cross-organizational processes of contract management. The system includes a contract management module having several functional dimensions that support the creation, collaboration, negotiation, approval, and analytics of complex contracts typical for highly customized products or services. The contract management module preferably is a Java based, n-tier, object-orientated application that is configurable and scalable.

The present system preferably utilizes Enterprise JavaBeans (EJBs) to enforce business logic and the workflow. Advantages of using EJBs as opposed to applets include increased portability and faster load times. EJBs also make it easier to release new versions of business logic. The present system integrates (two-way) with back-end systems in multiple enterprises. This enables information to be directly sent to all the parties involved and provides access to all parties and the ability to collaborate on large amounts of complex information that often resides in multiple back-end systems. The communication capabilities of the system enable organizations and applications to work as independent atomic units that have ability to utilize shared information assets.

The system includes a multi-step approval functionality that supports a cross-enterprise approval process. This process can include more than two enterprises. It also allows a subscriber to control when individual business object information is made available to other subscribers.

Additionally, the system is especially useful in the development of contracts that are supported by extensive proposals and supporting documentation. It does not simply offer a tool for generating consistent legal or other contractual phraseology.

The system offers web-base access and thus facilitates cross-organization processes and process flows. It enables enterprises to independently collaborate with each other without interference from a central clearinghouse Collaboration is facilitated by enabling action items, issue items, notes, and attachments to be attached to any object in the system.

The system further preferably provides a configurable permission model based on each object and utilizes Roles to assign specific permissions to groups of users.

It offers event driven communication capability, real-time metrics, calculation of cycle times, and analytics. And, it supports the ability to attach documents of any format (Word, JPEG, Project Plan) to any object in the system, as well as the ability to configure business logic around these attachments.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments shown, by way of example only, in the accompanying drawings wherein:

FIG. 1 is a depiction of a typical prior art manual contract management process;

FIG. 2 is a management overview diagram of the architecture of contract management system according to the invention;

FIG. 3 is another management overview diagram of the architecture of contract management system according to the invention;

FIG. 4 is a conceptual block diagram of a private version of a contract management module of the system according to the invention;

FIG. 5 is a conceptual block diagram of a public version of a contract management module of the system according to the invention;

FIG. 6 is a conceptual block diagram of a collaborative commerce network incorporating contract management modules and interface modules according to the present invention;

FIG. 7 is a conceptual block diagram of a further collaborative commerce network incorporating contract management modules and interface modules according to the present invention;

FIG. 8 depicts a simplified functional process for creating a contract or master agreement;

FIG. 9 depicts a functional process for creating a delivery order or purchase order using the contract management system according to the invention;

FIG. 10 depicts a functional process for populating data fields with contract information using the contract management system according to the invention;

FIG. 11 depicts a functional process by which parties to a contract may collaborate on information using the contract management system according to the invention;

FIG. 12 depicts a functional process by which contract information may be approved using the contract management system according to the invention;

FIG. 13 depicts a functional process by which approved contract information becomes accepted information for incorporation into a finalized contract document using the contract management system according to the invention;

FIG. 14 is a block diagram of a menu structure of the contract management system according to the invention;

FIG. 15 is a data display user interface of the contract management system according to the invention;

FIG. 16 is a data list page user interface of the contract management system according to the invention;

FIG. 17 is a report page user interface of the contract management system according to the invention;

FIG. 18 is an entity-relationship diagram of objects and relationships of the contract management system according to the invention;

FIG. 19 is an entity-relationship diagram of the administration system of the contract management system according to the invention;

FIG. 20 is an entity-relationship diagram of participant permissions levels supported by the contract management system according to the invention;

FIG. 21 entity-relationship diagram for a typical government procurement process using the contract management system according to the invention;

FIG. 22 is a generic flow diagram through certain of the software layers of the contract management system according to the invention;

FIG. 23 is a data page flow diagram through certain of the software layers of the contract management system according to the invention;

FIG. 24 is a list page flow diagram through certain of the software layers of the contract management system according to the invention;

FIG. 25 is a change status (approval) flow diagram through certain of the software layers of the contract management system according to the invention;

FIG. 26 is a flow diagram demonstrating how the contract management system according to the invention renders a generic web page that is viewable by a user;

FIG. 27 is a flow diagram demonstrating how the contract management system according to the invention renders a data web page that is viewable by a user;

FIG. 28 is a flow diagram demonstrating how the contract management system according to the invention renders a generic list web page that is viewable by a user;

FIG. 29 is a diagram of the typical states of contract document, object and task that occur throughout development of a contract;

FIG. 30 is a global application addressing method of the contract management system according to the invention;

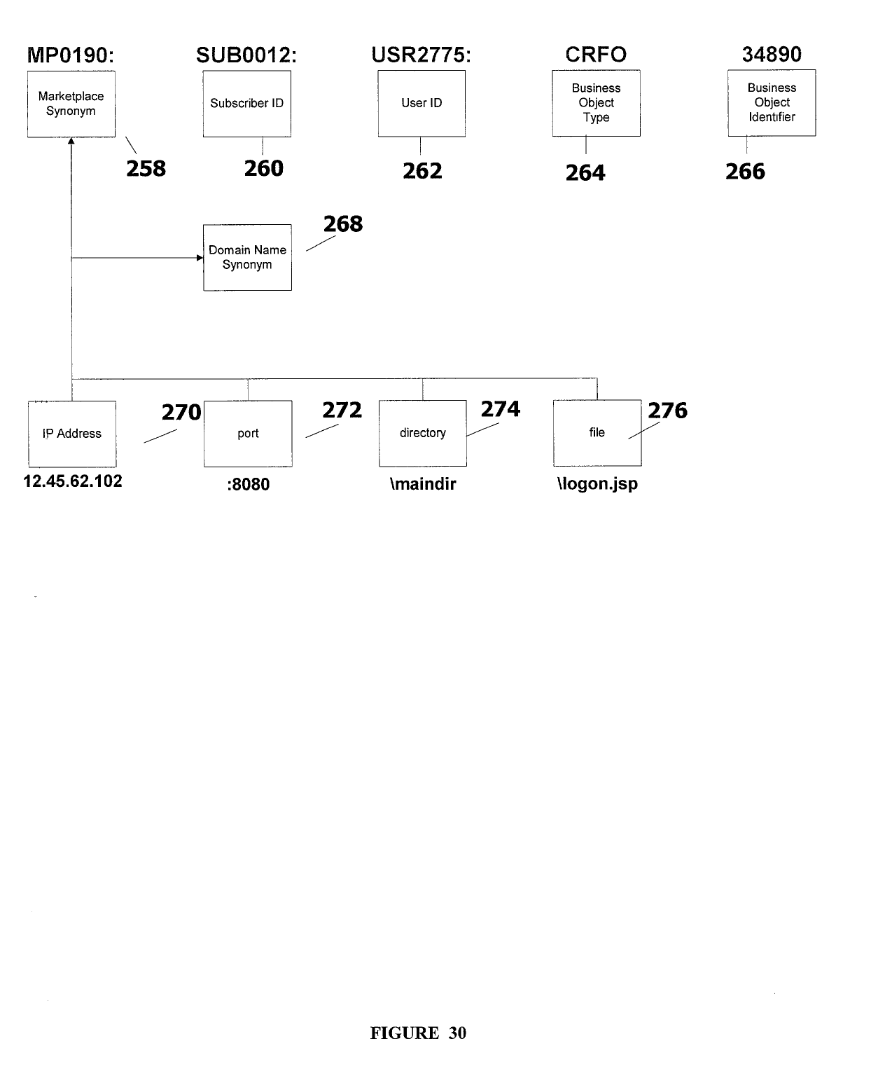

FIG. 31 is a core design of an interface module of the contract management system according to the invention;

FIG. 32 is a graphical user interface (GUI) flow associated with the contract management system according to the invention; and

FIG. 33 depicts the manner in which the interface modules of nodes of an interactive network incorporating the contract management system according to the invention interact with one another using messaging services.

### DETAILED DESCRIPTION OF THE INVENTION

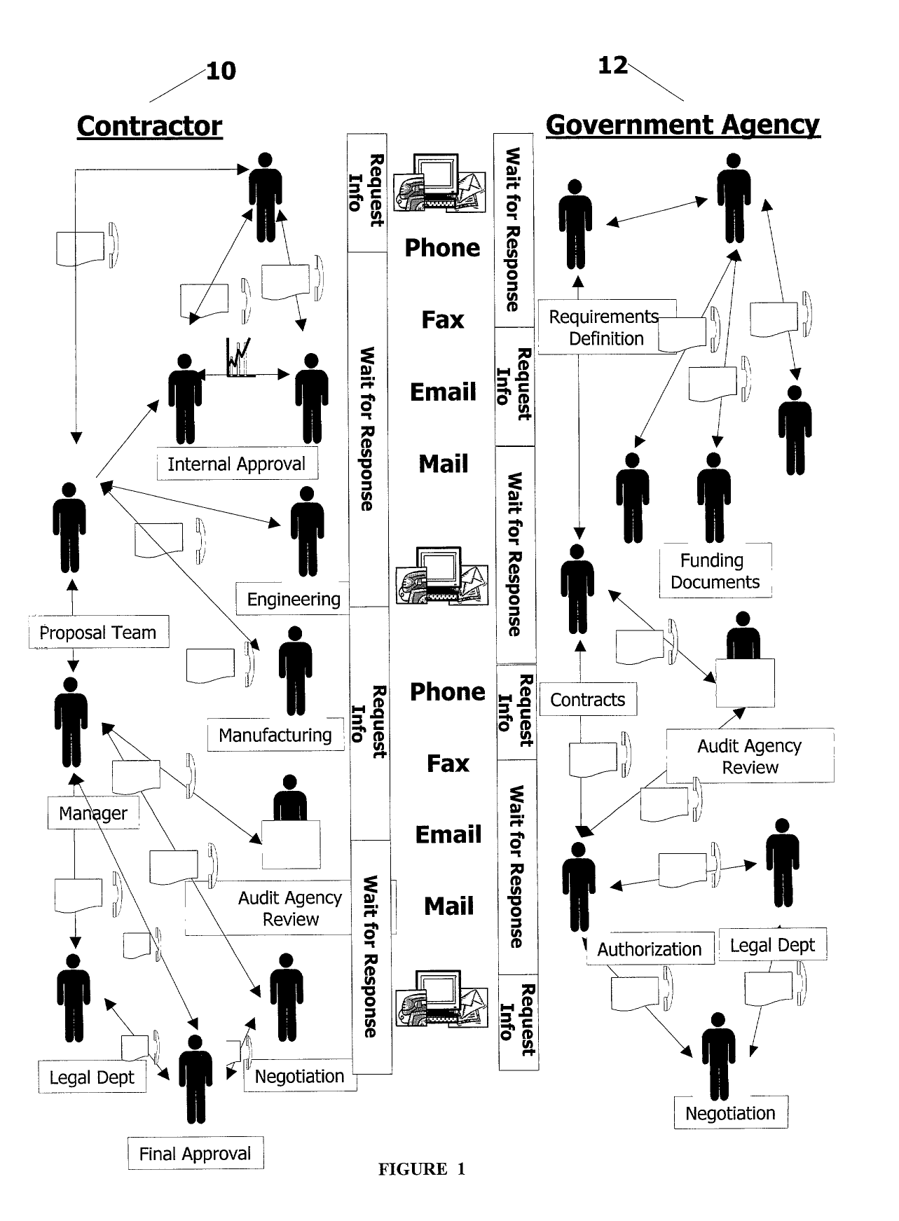

Referring to the drawings, wherein like references indicate like or similar elements throughout the several views, FIG. 1. illustrates a manual process for creating and negotiating a complex contract. As shown in FIG. 1, the process represents the manual process for creating and negotiating a typical government contract for the acquisition of engineered products or services between a government contractor 10 and a government agency 12 (although the features thereof may be found in or generally correspond to those encountered in complex contracts between other sophisticated business entities or organizations). The contracting process may be a highly interactive and lengthy process between the contractor and the agency. On average, cycle times for the execution of the contract are 120 days or greater. Much of the delay is caused by the serial nature of the process. This is combined with the challenges of exchanging information within and between the parties via postal services, electronic mail, facsimile, telephone or other communications systems. That is, for each request for information, whether internal or external, there is an attendant time period for which the requester awaits a response.

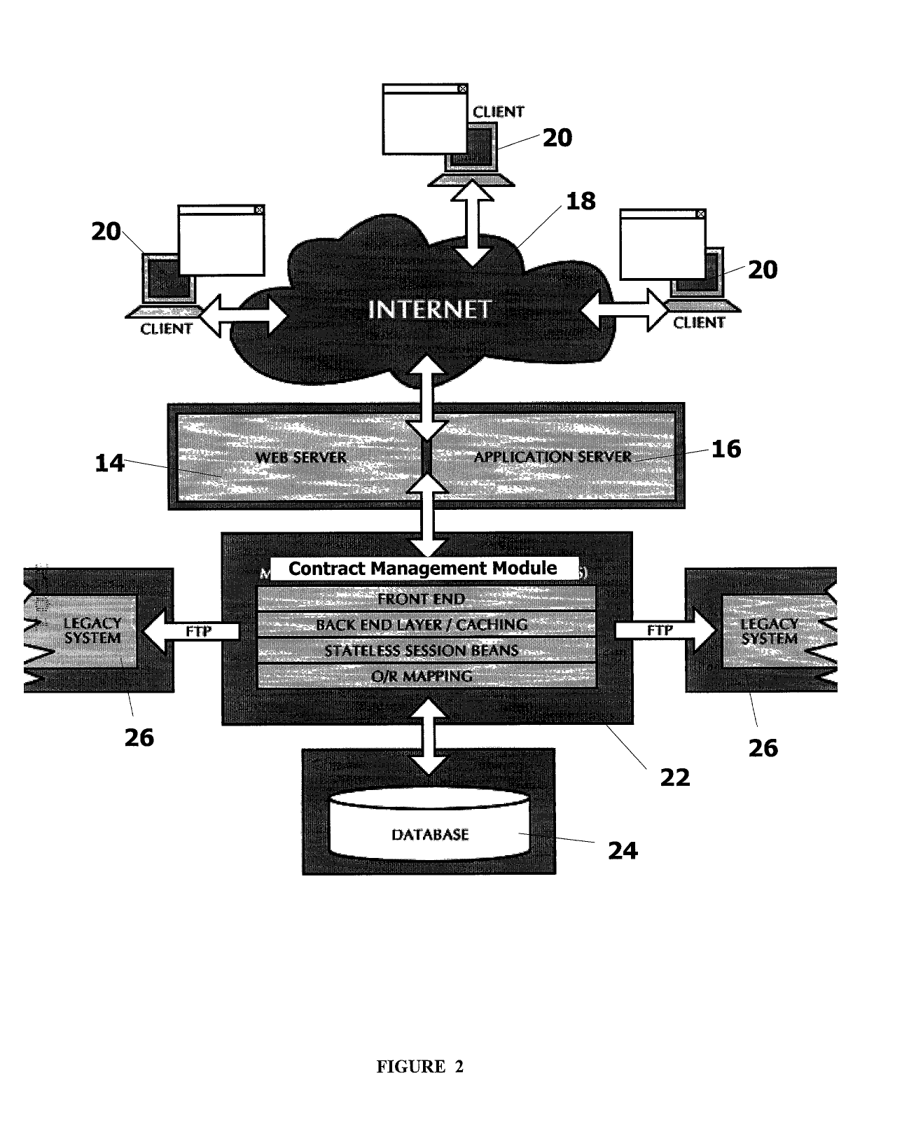

FIG. 2 is a management overview diagram of the contract management system according to the present invention. The invention can be used in any situation where interactive business processes which are facilitated through collaboration and span multiple organizations and/or departments within a single organization. The system, through a web server 14 and application server 16, communicates via the Internet 18 to a plurality of client computers 20. Client computers 20 may include any type of Internet-compatible communications or interface device, e.g., a personal computer (PC), a laptop computer, or a wireless device such as a personal digital assistant (PDA) or cellular telephone (cell phone).

At the core of the system is a contract management module 22. Contract management module 22 is comprised of five functional dimensions that enable contract creation, negotiation, collaboration, approval, analytics and storage.

The focus of contract management module 22 is to optimize and enhance highly-interactive processes which span multiple enterprises. This results in being able to realize greater benefits than just focusing on optimizing internal processes that only form one piece of the entire overall contract formation process. Utilizing the functionality of contract management module 22, multiple organizations can contribute and participate in the overall process in a parallel manner rather than in a serial manner. This allows multiple companies to contribute information at the appropriate times during the process as well as to receive critical information that is generated during a process without having to wait until that process is complete. For example, Company A may be required to provide a requirement definition and a supporting detailed proposal to its Customer, Company B. Using the system according to the present invention, including contract management module 22, Company A can make the requirement visible to other interested parties/organizations while simultaneously beginning its internal process of generating a detailed proposal. Once it is made visible or available for review by Company A, Company B can review and modify the requirement definition as necessary. These modifications can be immediately incorporated into Company A's proposal process, thus reducing the amount of rework that would be required if the modification had not be known until the completion of the proposal process.

Concurrently, Company B's process for the approval of requirements can occur. In addition, should a third party, such as an audit agency, be required to review the requirement, this review can occur simultaneously with the foregoing activities. Each organization can contribute information to and receive information from the shared process that spans multiple organizations while conducting their internal processes in parallel therewith, thereby resulting in the elimination of wait time which is inherent in serial processes and a reduction in the overall time and cost of the entire process.

Collaboration is a critical component in the interactive process of contract management. Contract management module 22 facilitates collaboration by offering: role based permissions, cross-organizational Action and Issue Items (described later) with automatic notification of new and modified Action Items and Issue Items relevant to the user, attachment of supplemental documents to any business object in the system, real-time statuses of business objects, configurable business rules to govern the use of information assets, easily administrated user groups and permissions, modifiable approvals and audit functions, and automated calculation of key metrics such as cycle time. As a result, contract management module 22 fosters close customer relationships by enhancing each user's ability to make more informed decisions which, in turn, increases work accuracy and efficiency and reduces redundant activities. Complex contracts may be executed more rapidly which reduces the time to market and time to revenue. The system and its method of operation also reduces the cost of the contracting process and provides the analytics for continuous cross-organizational process improvements.

Contract management module 22 communicates with a database 24 as well as with legacy systems 26 of an organization or business entity via File Transfer Protocol (FTP) or other suitable application protocol and Extensible Markup Language (XML), Hypertext Markup Language (XTML) and/or any information formats suitable for creating and sharing data on the Internet, intranets and elsewhere. Contract management module 22 preferably comprises a front end, a back-end layer/caching, stateless session beans, and object relational (O/R) mapping, described below. The preferred type of database 24 is Oracle 8i. The content and function of the database 24 is described later herein and typical back-end legacy systems 26 might include Enterprise Resource Planning (ERP) systems such as SAP, PeopleSoft, Oracle, JD Edwards or other legacy systems such as homebuilt customized applications.

The main code modules of contract management module 22 include the front end, middle tier and back-end. Since these are used in a layered approach with the front end making calls to the middle tier that in turn makes calls to the back-end, they will be discussed in reverse order.

The back-end module implements the core business logic of the application along with managing the persistence of all business data to and from the database. For contract management module 22, the back-end is preferably implemented as a series of stateless session EJBs. An EJB application server is preferred mainly for transaction management and load balancing for scalability.

According to a presently preferred embodiment, the back-end of contract management module 22 is currently implemented as a series of stateless session EJBs which are discussed in the following sections.

A BaseServiceEJB and the BaseService interface are the super class for all EJBs of contract management module 22.

Methods inherited from BaseServiceEJB fall into the following categories:

1. Initialization: This includes initialization of resources from Properties files, instance tracking, and logger initialization. It is preferred that the BaseServiceEJB include logging capability in accordance with the Log4j Project sponsored by the Apache Software Foundation. Instantiation and Management of an ORHelper implementation. For EJB containers with primitive Java Transaction API (JTA) implementations additional transaction management tools are provided.

2. Single source data manipulation methods applicable to all data objects extending a BaseIdObject, and data object retrieval from application-wide unique identifiers. The preferred base object and object relationships according to the invention are described later herein.

3. The BaseServiceEJB allows the subclass EJBs to implement specific business logic through the use of common tools whose implementation details are abstracted and in a standardized environment.

The EJB Services can be divided into standard contract management module services which support the functionalities described hereinafter and business object-specific services which contain functionality to support a specific hierarchy of objects. An exemplary, although not limitative, module would be a government procurement delivery order hierarchy.

O/R mapping binds Java objects to persistence mechanisms, in particular, relational database management systems (RDBMS) and XML documents. In addition, it is desirable that the O/R mapping tool manage issues such as locking and caching in a robust, performance and configurable manner. In the Java 2 Platform, Enterprise Edition (J2EE) framework, Entity Beans (a type of EJBs)fulfill this capacity in a limited manner. Advantages realized by de-coupling O/R mapping from the container include greater flexibility and complexity, increased functionality, and decreased reliance on vendor-specific solutions. Likewise, performance penalties and other drawbacks associated with entity beans are also avoided. The ORHelper interface defines the role of the O/R mapping in contract management module 22. Presently, in order to implement ORHelper an O/R Mapping tool must support inheritance.

Castor is an open source data binding framework for Java from the ExoLab Group. Castor is used as the Object Relational Mapping layer and is used to persist the Java objects to the Relational Database.

The middle tier is the bridge between front and back-ends. The main purpose of the middle tier is to abstract the back-end implementation from the front end. The abstraction layer is built using the following:

The system according to the invention preferably includes model classes that implement an object oriented representation of the data in the system. The classes are built to represent the data stored in the relational database using the O/R mapping described above. These classes only store data and provide the standard JavaBean get/set accessor methods. No business logic is implemented in these classes.

The most important model is the BaseModel. It is the root class of all other model classes in the system. It is analogous to the BASE_OBJECT table described below. All business methods that can operate solely on the elements contained within the BaseModel can be applied to any object in the system. The element most often used is ID, which is the primary key for the object in the database. This is used to build ad hoc relationships between objects.

A ModelCache is used as a temporary cache of model and wrapper objects (discussed hereinbelow) that are loaded during the processing of a single hypertext transfer protocol (HTTP) request. Its main purpose is to reduce the number of database calls to load the same object. It relies heavily on the fact that all model classes extend from the BaseModel and also the generic loading methods provided by the BaseService.

In information technology, a “wrapper” is data that precedes or frames the main data or a program that sets up another program so that it can run successfully.

On the Internet, “http://” and “ftp://” are sometimes described as wrappers for the Internet addresses or Uniform Resource Locator (URL) that follow. A set of bracketing symbols (such as <and>, used here to wrap the word “and”) are also sometimes referred to as wrappers.

In programming, a wrapper is a program or script that sets the stage and makes possible the running of another, more important program.

In data transmission, a wrapper is the data that is put in front of or around a transmission that provides information about it and may also encapsulate it from view to anyone other than the intended recipient. A wrapper often consists of a header that precedes the encapsulated data and the trailer that follows it.

In database technology, a wrapper can be used to determine who has access to look at or change the data that is wrapped.

A CallingContext is part of the middle tier but its primary use is to convey information to the back-end implementation. It may hold an identity of the user logged into the system and a link to that user's permissions within the system (discussed below). This allows the back-end to do permission checking of method calls.

As set forth above, the model classes hold the data for the application. The wrapper classes, on the other hand, contain the business logic. More specifically, the front end implementation calls into the wrapper classes to perform business logic. The classes themselves will either perform the business logic directly, forward it to the back-end implementation or do some combination of both. The wrapper classes provide the main abstraction in contract management module 22 by completely hiding the back-end implementation from the front end. Note that since the wrapper classes themselves implement some of the business logic, all front ends (web, graphical user interface (GUI), XML service, and so on) will need to interact with the wrappers and not go to the back-end directly. This is actually desirable as it permits the system administrator to move to different back-end implementations as the need arises.

The front end module contains the code that directly interacts with the user. Since contract management module 22 is a web based application, this code resides on the server. Its main purpose is to process HTTP requests from the client browser, making calls to the other modules as necessary and to render HTML pages that provide the interface to contract management module 22.

Preferably, contract management module 22 includes an event processor that performs specific actions as the result of the events that occur on objects. As work is done on objects in the system, events are logged to an event queue to record what activity took place. The event queue acts as an audit trail of the activity on an object, but it also functions as the input to the event processor. The event processor is implemented as a standalone process that monitors the event queue for new events. When a new event is entered, the processor analyzes the event and performs specific actions based on the event type and the object the event occurred on. The event processor determines which actions to take by processing a series of business rules that are either associated directly with the object or are based on the type of object. The rules based on object type are coded into the core contract management module 22 application and desirably allow very little modification. The rules attached directly to objects are implemented through a facility referred to herein as object watches and are the primary way that users attach special processing instructions to events in the system.

An object watch is a method for the user to specify an action to occur when a certain events take place on a specific action. It is a way for the user to express, for example: “Whenever Events A, B or C occur on Object O, please perform Action X.” The standard set of events that occur in the system are: Create, Read, Update, Delete, Change Status and Assign. According to a presently preferred embodiment of the invention, the following actions can be taken as the result of an event:

a reference to the event may be inserted into a user's login notification queue;

an email may be sent to a set of users;

a message may be broadcast to interested marketplaces (available when interface module 28, described below, is installed);

a message may be queued to be sent to a specific set of marketplaces (again, available when interface module 28 is installed); and

a file may be sent to a server.

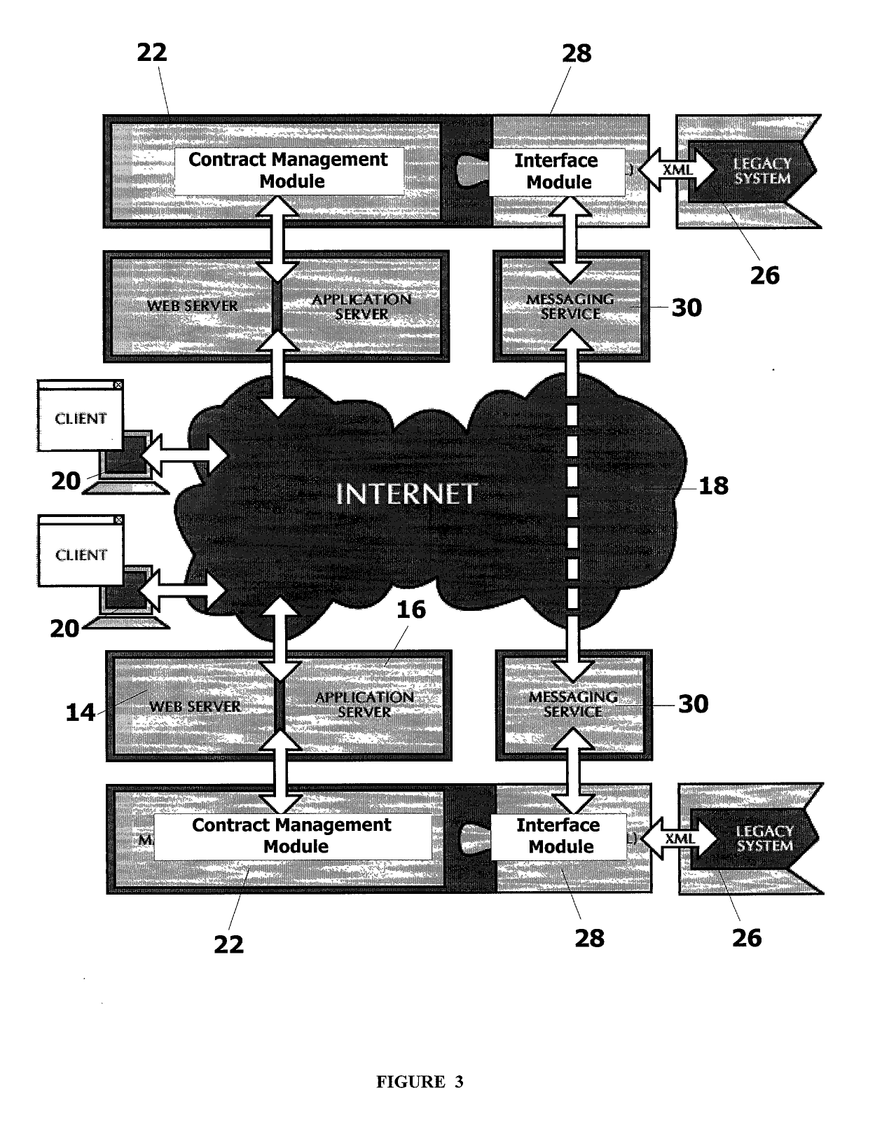

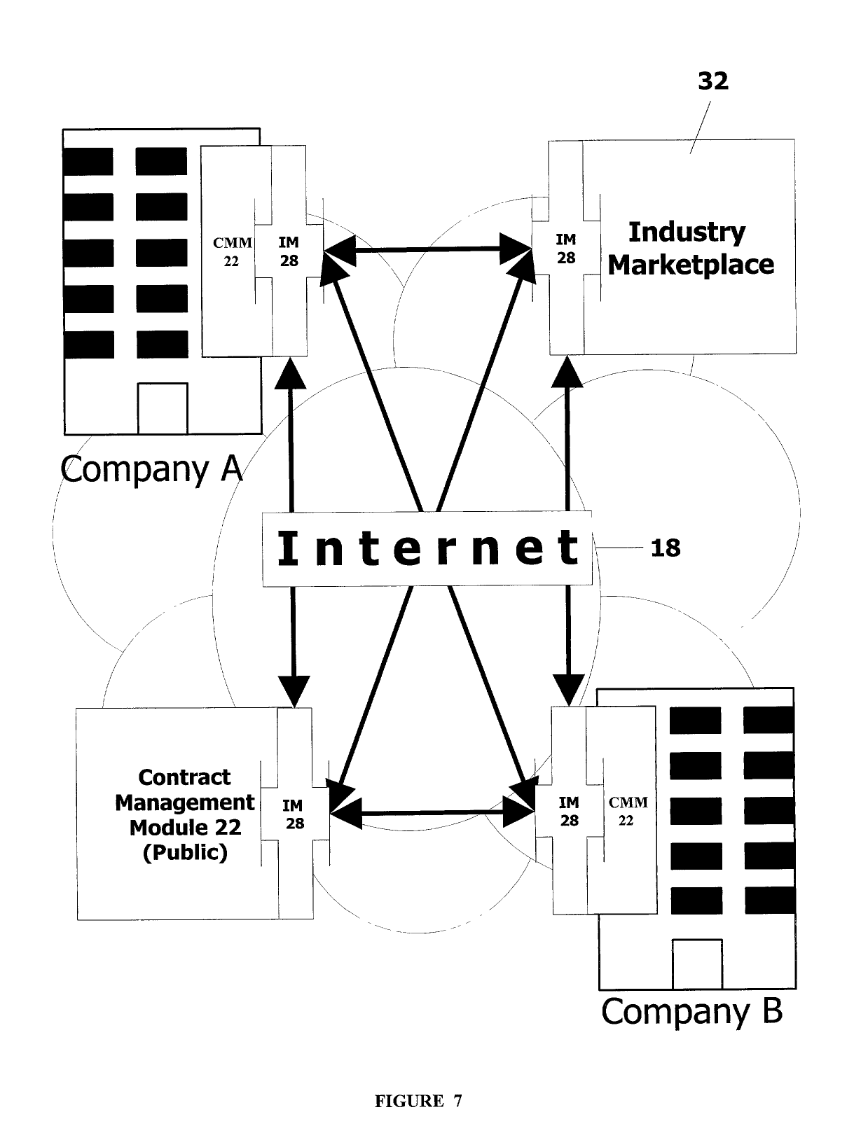

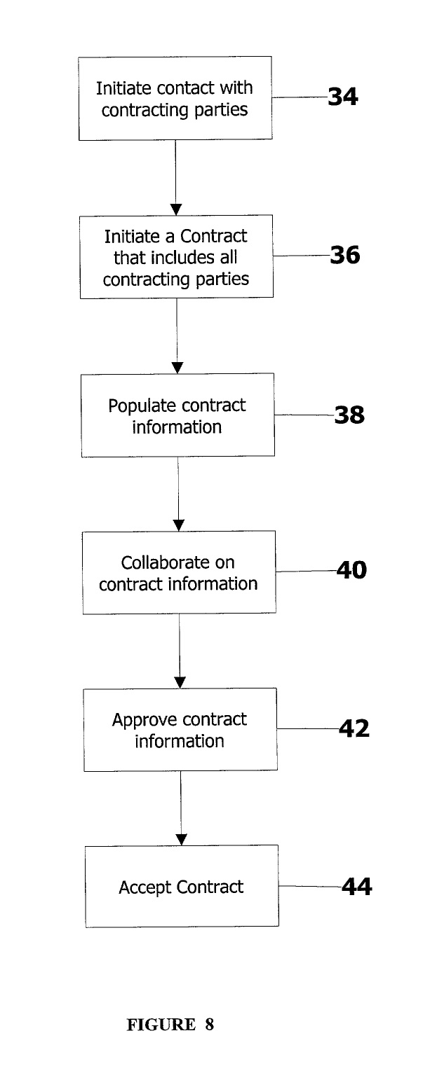

FIG. 3 is another management overview diagram of the contract management system according to the invention, including contract management module 22 and an interface module 28. Interface module 28 is the communication module of the present system and provides the interfaces, communication methods, common protocols and formats to integrate multiple back-end systems, applications, electronic markets and other installations using contract management module 22 together in a virtual network. As will be more readily appreciated by reference to FIGS. 7 and 8 and their attendant descriptions, interface module 28 serves as a universal interface for integration with other applications, regardless of their particular technical architecture or whether they are associated with proprietary or private networks.

Utilizing contract module 22 and interface module 28, organizations that participate in contract formation realize the following benefits: visibility of the entire array cross-organizational contract management processes, access to collaborative tools for the proactive resolution of Action Items and Issue Items (discussed hereinafter), availability of real-time status information, and the ability to utilize information assets from internal systems and data shared across organizations throughout the contracting process. By serving as a node of a virtual network, sometimes referred to as an “OpenWeb”, interface module 28 allows data to remain under the control of a data “donor” organization while still enabling collaboration with multiple organizations to occur. That is, the interface module provides the tools and methods in necessary for a viable platform for cross-organization collaboration.

As illustrated in FIGS. 3 and 7, suitable messaging services 30 such as Sonic MQ. enable communication between the interface modules 28 of linked industry marketplaces 32, public and/or private contract management modules 22, through the Internet 18 or other broadband communications network medium.

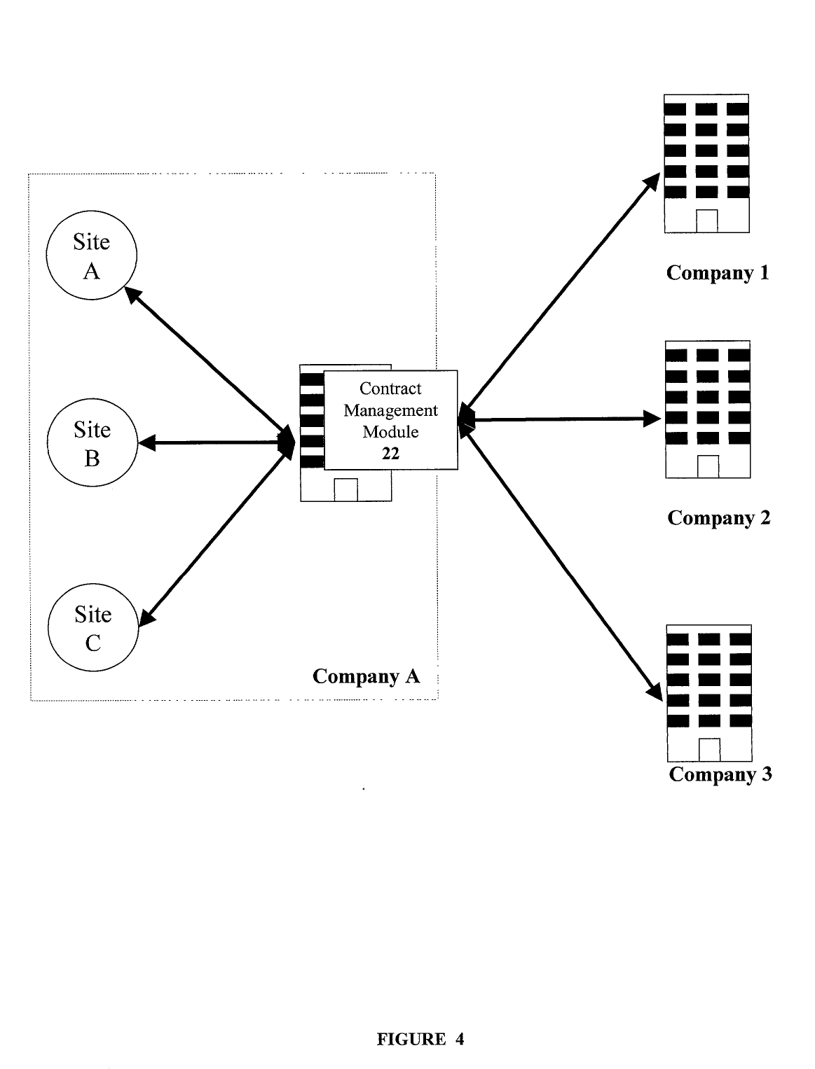

In FIG. 4, a block diagram shows the use of contract management module 22 by Company A to manage their contracting processes. Company A can manage both the internal contracting process, which may require interaction and collaboration between multiple Sites or departments A, B C and so on, and the external contracting process which requires interaction and collaboration with Companies 1, 2, and 3. This figures depicts a private installation of contract management module 22 within Company A's firewall and network. According to a presently preferred implementation of the present system, as the user or licensee of the contract management module 22 software, it is Company A that determines the business rules and process that will govern the collaborative environment. Companies 1, 2, and 3 access contract management module 22 via the Internet or other broadband network and the individual Sites A, B and C can either access contract management module 22 via the Internet or a company Intranet. The only software required to access contract management module 22 via the Internet is a standard Microsoft, Netscape, or equivalent browser that is capable of 128 bit encryption and any commonly available connection to the Internet. Pursuant to this particular embodiment of the invention all of the software and hardware required to facilitate the contract management process preferably exist at Company A. Data security may be enforced through the use of 128-Secure Socket Layer (SSL) or other suitable encryption technologies. In addition, the option to enable a Virtual Private Network (VPN) also may be implemented.

Depending on the contract that is being negotiated, any of the Companies in FIG. 4 can assume the role as the buyer, seller, or auditor of a contract. For example, in the Aerospace and Defense Industry, Company A could represent the Contracting Office of a military branch. In order to fulfill its requirements for replacement parts for F-14 aircraft, for example, Company A might negotiate a contract with a Defense Contractor (Company 1), such as Boeing Corporation. However, before the contract can be finalized, it must be reviewed, audited and approved by an independent government agency such as the Defense Contract Management Agency (DCMA). In this scenario, the Government Contracting Office (Company A) is the buyer, the Defense Contractor (Company 1) is the seller, and the Independent Government Agency (Company 2) is the auditor. Using the persent system, all three of these organizations have visibility of the overall process throughout contract negotiation. In addition, contract management module 22 provides the tools and ability for all three organizations to collaborate with each other, to enforce a multi-organization approval process, and to contribute information assets, such as shared bills-of-material (BOMs). It will be appreciated that this scenario may exist in any industry where contract negotiation requires the involvement of an independent organization as an auditor.

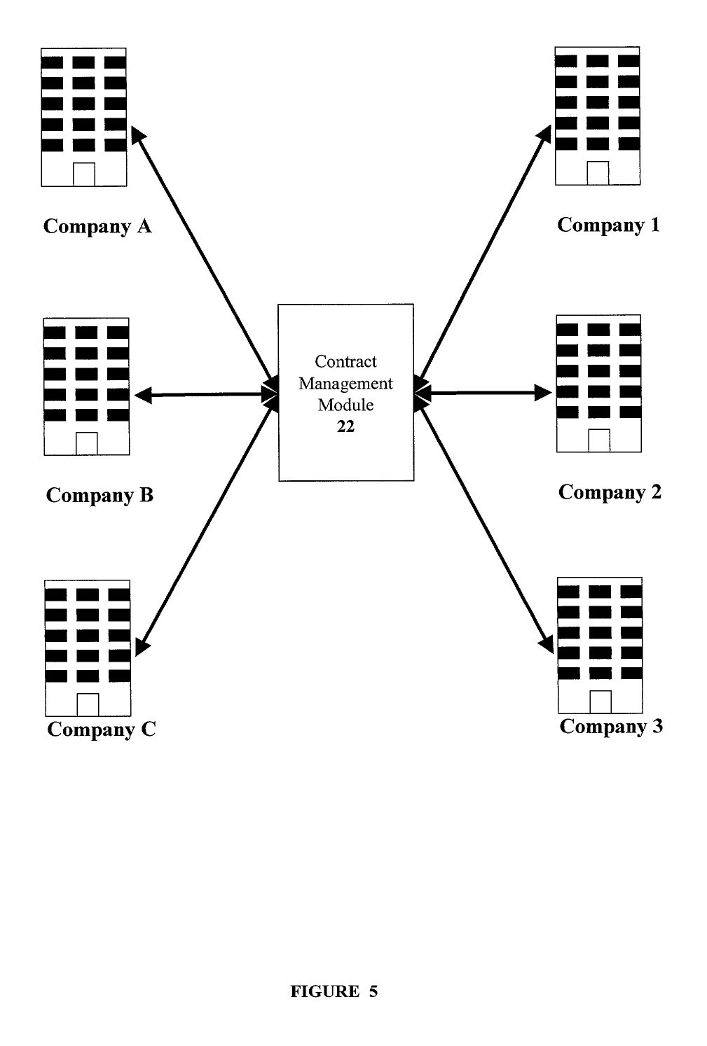

In contrast to FIG. 4, FIG. 5 is a block diagram that depicts a public installation of contract management module 22. In this scenario, contract management module 22 is implemented as a hosted solution and the hardware and software required to facilitate the contracting process are located at neutral third party provider. In this embodiment, contract management module 22 is accessed by all the participating Companies (Subscribers) A, B, C, 1, 2, 3 via the Internet. In this scenario, a consortium of companies come together to establish one collaborative environment as peers with no one organization owning the application. As a result, the companies within the consortium mutually agree upon the business rules and processes that govern the collaborative environment. A second unillustrated example of this scenario is for one company to implement contract management module 22 in a neutral location in order to provide a service to other companies. For example, a company may choose to implement contract management module 22 to provide contract management services to small businesses and charge the small businesses for their use of the application.

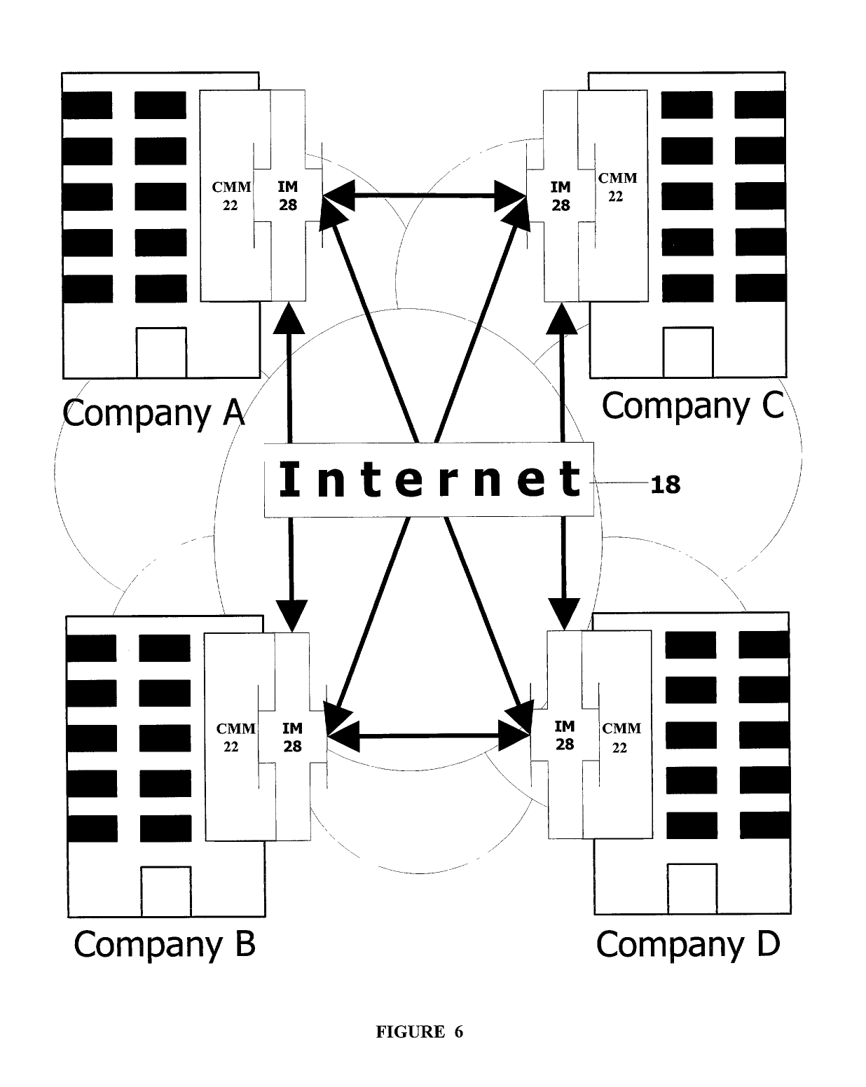

FIG. 6 is a block diagram that depicts the implementation of both contract management module (CMM) 22 and interface module (IM) 28. This scenario establishes an open network between multiple organizations such as Company A, Company B, Company C and Company D via the Internet 18. So connected, the organizations can participate in a virtual collaborative environment to create and negotiate complex multi-party contracts. Each installation of contract management module 22 can be viewed as a “node” on a virtual network. By utilizing the communication and transaction functionality of interface module 28, collaboration thus occurs in a virtual workspace. As a result, each node maintains control over their specific environment and their ability to customize the present system without compromising the ability of communicating and negotiating with other organizations. That is, with each installation of contract management module 22 serving as a node on a virtual network, each organization has the ability to utilize their highly confidential information assets throughout the negotiation process without relinquishing control or ownership of this data. As a result, each organization maintains control of who sees the data and when it is available to be seen other organizations.

In addition, by utilizing the interface module 28 integration capabilities, an organization has the ability to collect from its multiple back-end systems all the relevant information required to be effective during the negotiation process. This ability enables the users of the system to make more informed decisions as well as reduces cycle time by eliminating the need to re-key information that is already available in electronic format.

The communication and transaction capabilities of interface module 28 are platform independent. Hence, a node can be any type of application. To illustrate, FIG. 7 is a block diagram that depicts a collaborative commerce network incorporating the system according to the invention that is facilitated through expanding the virtual network to include an Industry Marketplace 32. The focus of Industry Marketplaces is to facilitate general transactions, usually procurement-based, between many buyers and suppliers. This access to a large number of buyers and suppliers can be leveraged to enhance the benefits realized by using contract management module 22 to enable the contract management process. For example, in FIG. 7, Company A could be negotiating a complex made-to-order contract with Company B. In order to provide current market prices and quotes to support the prices included in a bill of materials, Company A can send a request-for-quotation (RFQ) to a broad selection of suppliers who participate in the Industry Marketplace. By receiving bids and quotes through contract management module 22, this information can be easily included in the detailed proposal required by Company B. In addition, Company A has the ability to consummate the deal and establish a new relationship with the supplier who provides the most competitive bid.

Generally, the contract management process for complex contracts requires a high-level of interaction between organizations and incorporates several sub-processes. FIG. 8 is the functional business process flow that depicts a high level contracting process supported by contract management module 22. In the first step of the process, identified herein by reference numeral 34, contact between the contracting parties is initiated. Then, at step 36, a contract that includes all of the contracting parties is initiated. At step 38, the contract is then populated with information relevant to the contract. The parties to the contract and other organizations involved in the contract collaborate on contract information at step 40. Contract information is approved at step 42 and the contract is finally accepted at step 44.

The foregoing process is shared by all organizations that are involved with the creation, collaboration and negotiation of a contract. Contract management module 22 provides a collaborative environment that is governed by configurable business rules for this process to occur. By establishing business rules that streamline and optimize the overall cross-organization process, each individual organization involved benefits from a more efficient process. Process efficiencies are documented and monitored by contract management module 22 by the configuration of metrics and reports based on both user and system events. Unlike internal process analysis, contract management module 22 provides real-time data and analytics based on actions/activities of all users, across multiple organizations, that are involved in the process.

A contract represents a master agreement that establishes the terms, conditions, total value and/or quantity of goods and/or services that will be transacted between entities or organizations in the future. When an organization requires the transaction of the goods/services referenced in the contract, a Delivery Order (DO) or Purchase Order (PO) must be created and executed to release the products/goods from the contract. Delivery Orders/Purchase Orders define in more detail the products/services that are to be delivered as well as the specific details (e.g. delivery instructions) for those products/services ordered.

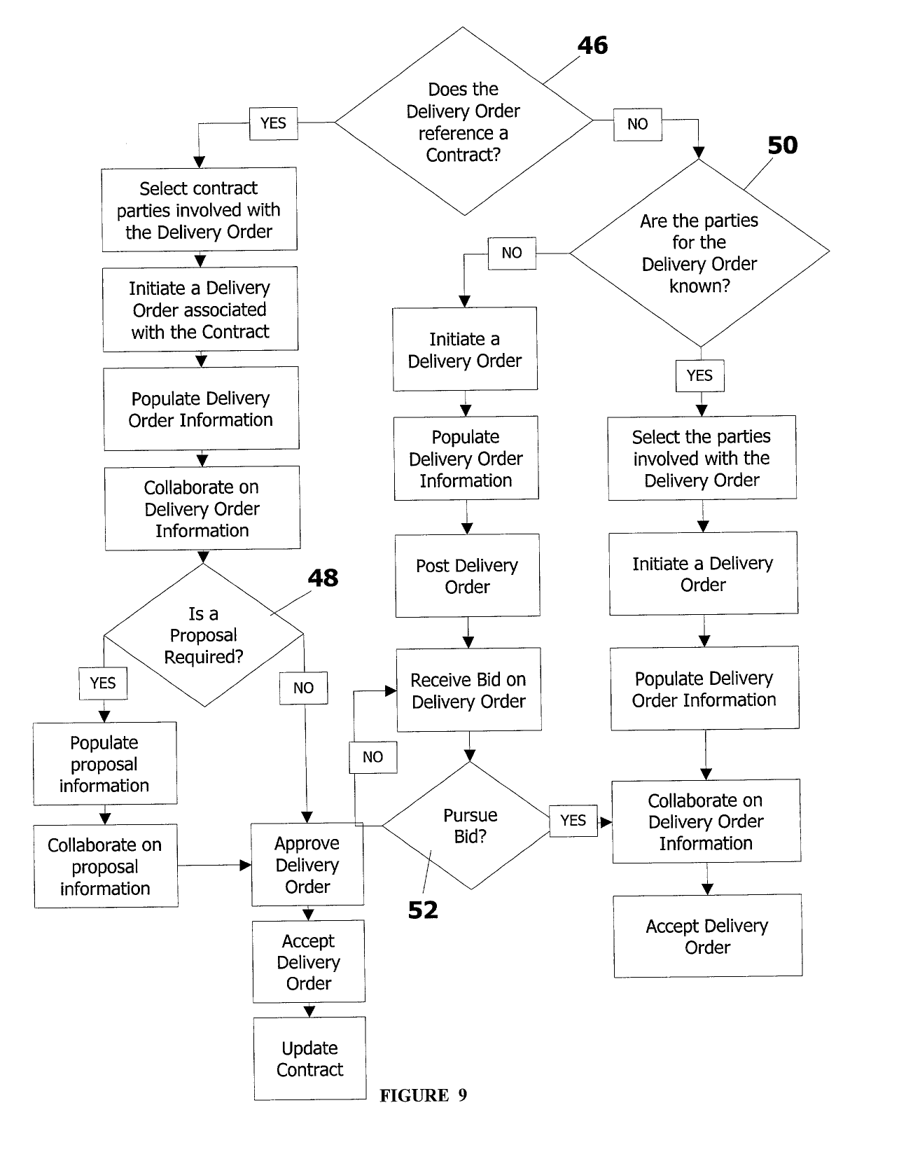

FIG. 9 is the functional business process flow for the creation of a Delivery Order (or Purchase Order) in contract management module 22. Contract management module 22 facilitates the creation of complex Delivery Orders/Purchase Orders by incorporating detailed proposal information, such as a BOM, with each Delivery Order. The first step in the process (reference numeral 46) is to determine whether the order references a specific contract. If it does, contract management module 22, selects the contract involved with the order, initiates a DO/PO associated with the contract, populates the order with the appropriate information and permits the interested entities to collaborate on the delivery information. Following this, contract management module 22 determines at step 48 whether a proposal is required to complete the order. If so, the proposal is populated with the appropriate information and the interested entities are permitted to collaborate on the information. Once the interested entities are satisfied with the DO/PO information (and the proposal information if a proposal is required), the entities approve and accept the order and the contract is updated accordingly.

If the exchange of products/services does not reference or require a contract, contract management module 22 also supports the creation of an unassociated Delivery Order/Purchase Order. This functionality supports the scenario of a one-time spot buy or between organizations that may not maintain a long-term relationship.

As also shown in FIG. 9, in the situation where the specific seller has not been established with an existing contract, a non-associated Delivery Order/Purchase Order may be created in contract management module 22 to effectuate processing of the order. The business logic of contract management module 22 then determines at step 50 whether the parties for the delivery order are known. If they are, the system selects the parties involved with the order, initiates a delivery order, and the delivery order is populated with information. The interested entities are then permitted to collaborate on the information. As before, once the interested entities are satisfied with the DO/PO information (and the proposal information if a proposal is required), the entities approve and accept the order.

If the parties to the PO/DO are not known, contract management module 22 initiates the order and the order is populated with order information. It is then posted and bids are received. The entity placing an order may then choose, at step 52, to pursue or not pursue a particular bid. If the bid is not pursued, additional bids are then received until a bid is pursued. When a bid is pursued, the parties to the order, collaborate on the order information and finally accept the order.

The foregoing can be facilitated by assigning “states” or statuses to business objects. For example, once the buyer completes the unassociated Delivery Order/Purchase Order, a state is set identifying the DO/PO business object as an RFP, and it may be distributed to either a selected group of sellers within the private contract management module 22 community or to a broad group of potential sellers in public communities utilizing interface module 28. Bids and proposals can be submitted directly to the buyer utilizing contract management module 22 attachment functionality. Utilizing contract management module 22, the buyer can then issue an RFP and review the submitted bids. The negotiated and agreed upon Delivery Order/Purchase Order will be represented by changing its state to “approved.” As a result, all of the information associated and relevant to the procurement is captured for the entire lifecycle of the procurement. Similarly, a seller with excess inventory can undergo a similar process by posting a unassociated Delivery Order/Purchase Order, with the state of being a “sell” order, in order to sell his excess inventory and/or to attract a new buyer.

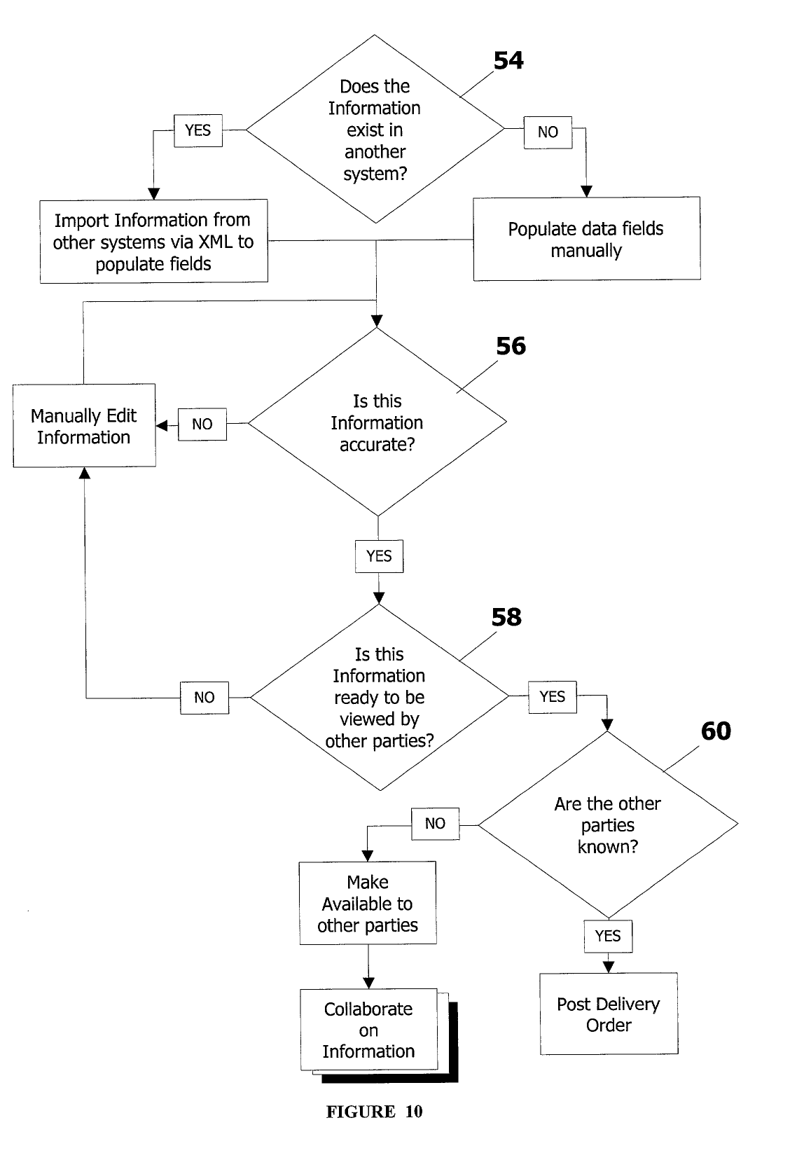

Collaborating and negotiating a complex contract involves the documentation and exchange of a significant amount of information. Contract management module 22 enables the population of data fields by both manual input via a user interface and also automated population via interface module 28 that can be integrated with other applications that provide such information. FIG. 10 is the functional business process flow for the population of data in contract management module 22.

As seen in FIG. 10, the business logic of contract management module 22 first determines at step 54 whether the information exists in another system that is in communication therewith. If the answer is no, the data fields must be manually populated by a user through interaction with a graphical user interface (GUI) or some other suitable interface. If the answer is yes, then the system automatically imports the necessary information from other systems in the network via XML or other suitable format and populates the data fields accordingly. In either case, the system inquires at step 56 whether the populated information is accurate. If it is not, then the information is manually edited and again checked for accuracy.

Once the information is accurate, the system determines at step 58 whether the information is ready to be viewed by other parties. If not, it is again checked for accuracy and manually edited again, if necessary. If the information is accurate, the system asks at step 60 whether the other parties are known. If the answer is yes, the order is posted. If the answer is no, the information is made available to the parties to the order and they collaborate on the information as desired.

To ensure the leveragability of contract management module 22 across all sizes and types of organizations, manual entry is available for all data fields. In addition, data that is commonly used on every contract and that remains relatively constant for an organization (e.g., user contact information, billing addresses, etc.) is maintained in a master data file. Each subscriber preferably has the ability to update and maintain this master information manually or automatically via integration with existing systems. The master data is made readily available throughout the process via drop down boxes and/or auto-population of specified fields. For organizations that utilize interface module 28 to integrate to their existing back-end systems, Enterprise Resource Planning (ERP) systems, or other applications, specific data relating to the contract management process can be automatically imported into contract management module 22. The contract management module provides the donating organization with a view of the data that is specifically relevant to the contract management process as well as the ability for the donating organization to share this information with another company or other entity without forfeiting control of the information. The owner of the information maintains control of the information throughout the entire contract management process and determines, by criteria established in the business logic of contract management module 22 at step 58, when the information is ready to be shared and collaborated on with other organizations.

Any organization that is involved with the contract or Delivery Order/Purchase Order can donate information assets throughout the entire process. This functionality is critical where the buyer possesses the detailed requirements for the requested product/service, but does not have the ability to contribute this information to the proposal process. Typically, during the conventional contracting process that is managed through a manual process, the seller controls the proposal process and there is limited visibility to the buyer. As a result, the seller would be required to re-create information instead of re-using work that was already done. This results in a higher overall cost of procurement and increased time to complete the proposal. This is a significant problem for both buyers and sellers in industries that deal with highly specialized or engineered products. Contract management module 22 addresses this problem by enabling visibility of the proposal process to all involved parties at the appropriate time as well as providing a method for each party to donate information relevant to the contract or Delivery Order/Purchase Order. For example, if a buyer has the detailed bill of materials in their ERP or back-end system from a prior procurement of a similar product/service from another vendor, then contract management module 22 enables the buyer to donate this information during the proposal process.

Effective contract management is dependent upon having the relevant information available for the participants to make informed decisions. Contract management module 22 captures all the information and data that is utilized to create the contract and/or Delivery Order/Purchase Order.

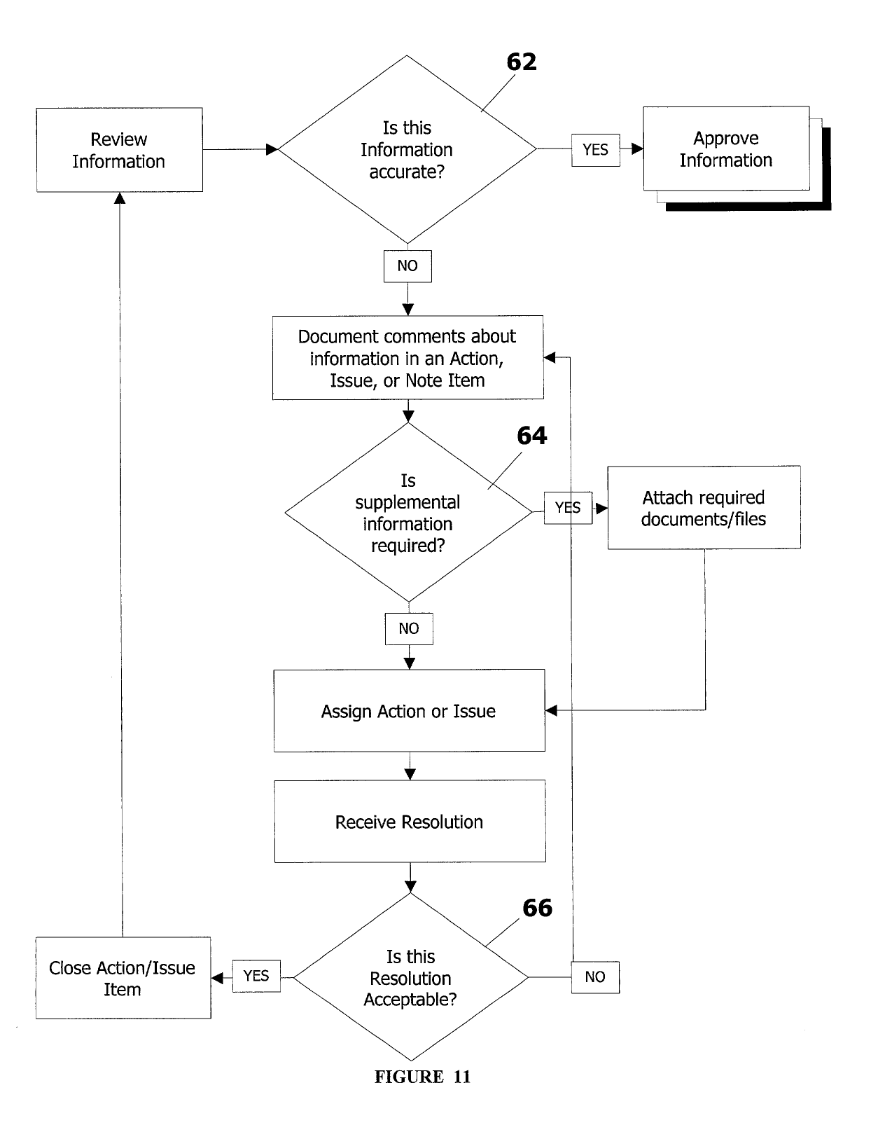

FIG. 11 is the functional business process flow for collaboration in contract management module 22. At step 62, the system determines, with the relevant parties' input, whether the collaborated upon information is accurate. If so, the parties approve the information. If no, a party or parties document comments about the information in an Action Item, an Issue Item or a Note Item that may or may not be attached to an object of the contracting process. As used herein, an Action Item is an item of information that is used to capture, assign, and monitor specific tasks that need to be completed by a specific date; an Issue Item is an item of information that is utilized to request possible resolutions to outstanding problems or issues; and a Note item is utilized to capture a user's comments on a specific object in the system. At step 64, the system asks whether, based on the business logic of contract management module 22, supplemental information is required for the item in question. If the answer is no, the item is assigned an “Action” or an “Issue” and receives a resolution from a subscriber. If the answer is yes, the required documents/files are attached to the item and the item is likewise assigned an “Action” or an “Issue” and receives a resolution.

At step 66, the system asks the collaborators whether the resolution is acceptable. If the answer is no, the system documents comments about the item and reprocesses the item. If the answer is yes, the system closes the Action/Issue item, the information is again reviewed for accuracy, and approved if accurate.

In addition to capturing the actual contractual data, contract management module 22 provides the tools for each user to collaborate with users in multiple organizations to facilitate the creation of accurate and comprehensive documents. Contract management module 22 preferably provides tools to document questions, concerns, and discussions as well as to assign and monitor Action and Issue items across multiple organizations. In addition, any supplemental information such as text documents, engineering drawings, project plans, and so on, that may be required for clarification of any object in the system (e.g., the contract itself, a Delivery Order/Purchase Order, an Action Item, etc.) can be attached directly to the object, Every object has an audit trail of the events that have occurred to the object and the versions of its attachments. As a result, many problems that exist today in the manually managed contracting process, such as version control of both electronic and hardcopies and the difficulty of collecting and accessing all relevant information, are eliminated.

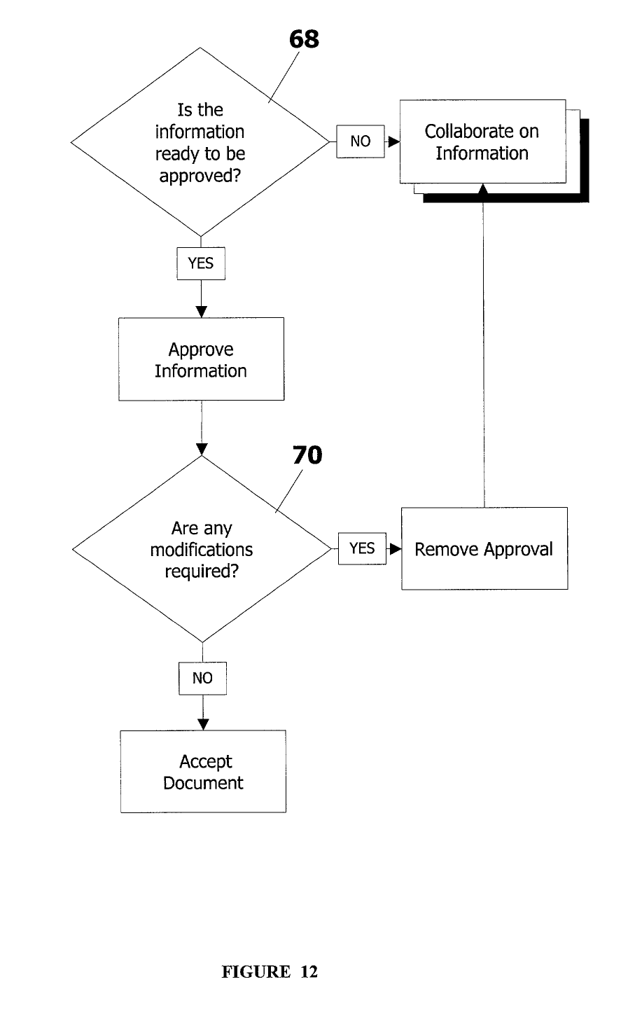

FIG. 12 is the functional business process flow for the approval process. At step 64, the system asks whether the information in question is ready for approval. If the answer is yes, the information is approved. If the answer is no, the interested parties collaborate on the information. At step 70, the system asks whether any modifications to the information are required. If the answer is no, the system removes the approval status of the information, and the information is returned to a state where it may be collaborated upon. If the answer is yes, the document is accepted.

Approvals may be required at many different stages during the process and are configurable based upon user events, system events, states of object, Subscriber, Users, User Roles, and User Groups. Unlike the disjointed manual process that is typically used to manage the contracting process, contract management module 22 enables an approval process that may span multiple organizations as well as the ability to manage approvals internal to the organization. Approvals are available on any object in the system. In order to control the integrity of the data, once an object has received one approval, the object is preferably no longer able to be modified until it has been changed to a different state or the approval has been removed. Contract management module 22 desirably facilitates the general approval process by making all the necessary information continuously available from any computer with an Internet connection. Also, since there is only one master copy of the data, version control problems associated with dispersing either electronic or hardcopies of the contract are eliminated. In addition to increasing the availability of accurate information, contract management module 22 provides the tools for the users to be proactive in managing the approval process as well. These tools include configurable automated alerts to notify managers of information such as deadlines that are in danger of being missed and significant delays caused by lack of action by a user. By having the visibility and real-time status on the approval process, both within and among organizations, users can use the collaborative tools of contract management module 22 to provide additional information required for clarification, follow up with users or their managers to determine the cause of the delay, and immediately respond to any questions or concerns which may be prohibiting the approval from occurring. Business rules, which determine what approvals are required during the process and how an approval affects an object, are configurable to support the approval process. Based on the configurable approval process, once an object has met the criteria of being in its final approved state, the object is ready to be accepted.

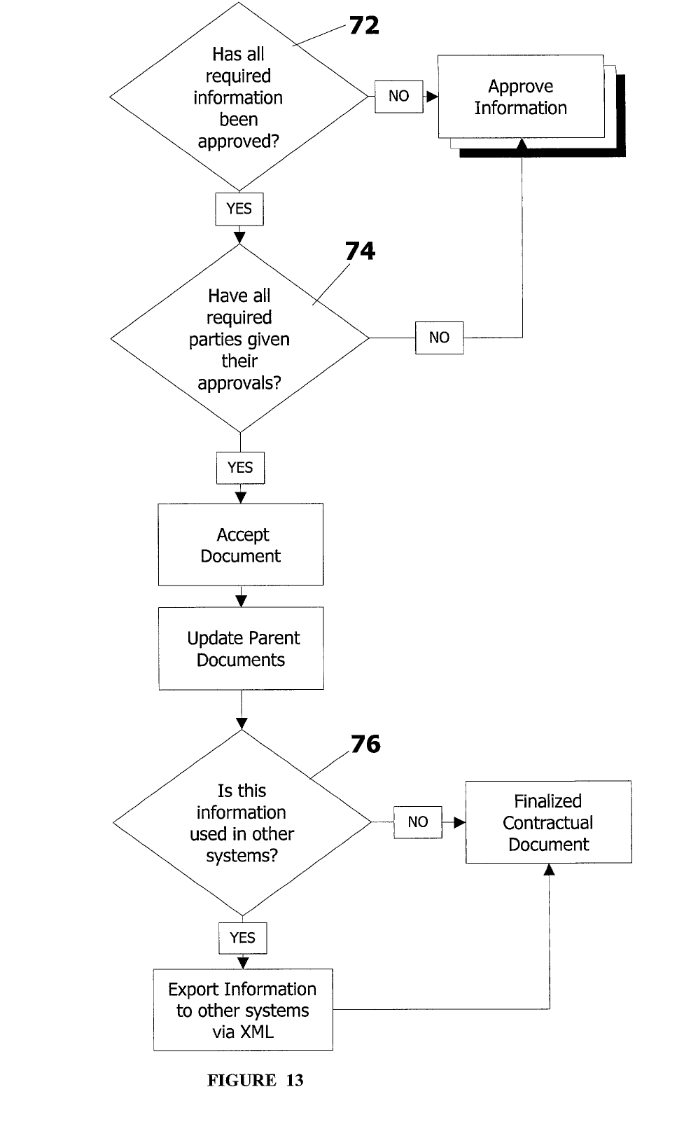

FIG. 13 is the functional business process flow for the acceptance of an object. This process may be automated or may require user confirmation for it to be finalized. In order to continue to facilitate the integration of information and systems, the finalized accepted documents can be exported into other applications or back-end systems using interface module 28. At step 72, the system determines whether all the required information for a particular object has been approved. If the answer is no, the object is returned to the appropriate entity or entities for approval. If the answer is yes, the system asks at step 74, whether all required parties have given their approvals. If the answer is no, the object is returned to the appropriate entity or entities for approval. If the answer is yes, the document is accepted and its associated parent documents are updated to reflect its acceptance. At step 76, the system asks whether the accepted information is used in other systems. If the answer is no, the document is converted into a finalized contract document. If the answer is yes, the information is exported to other systems via XML or other suitable format where it may be converted into a finalized contract document.

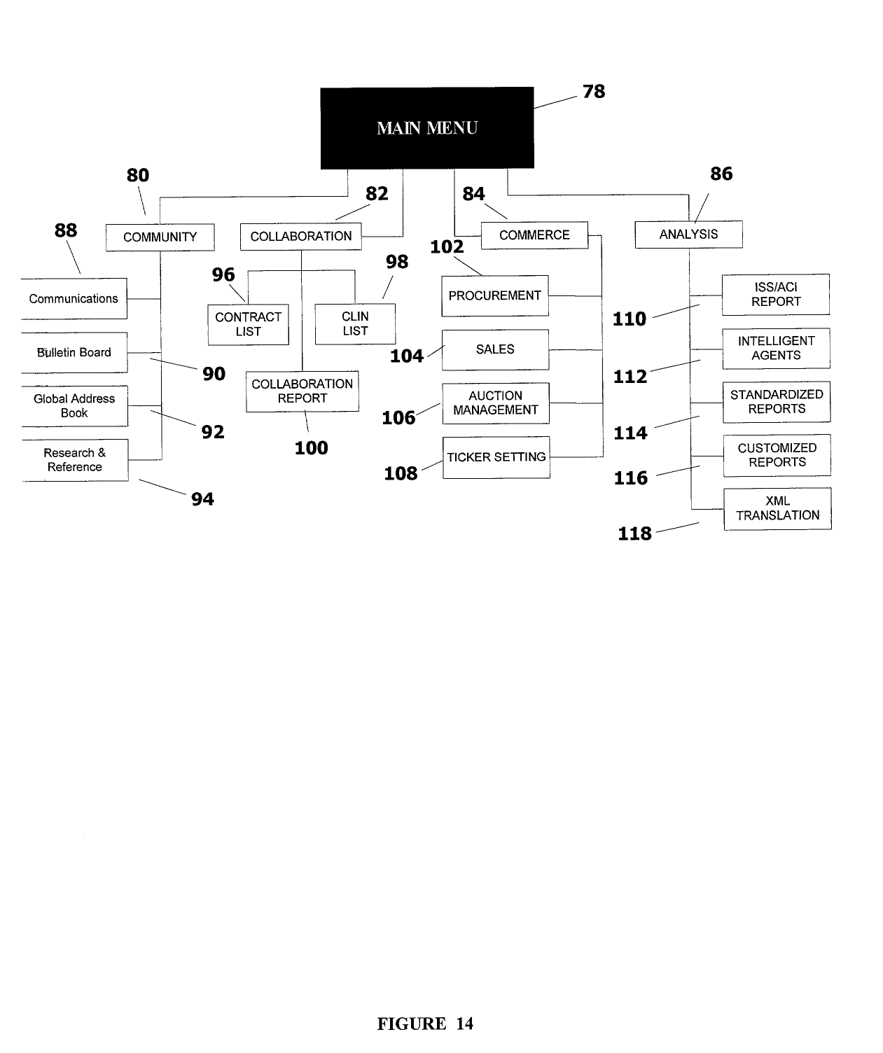

FIG. 14 is a block diagram of the overall menu structure for contract management module 22. Being a modular application, the system is designed with the ability to enhance the current functionality as well as to integrate additional modules. FIG. 14 depicts the relationship and hierarchy of the objects supporting the contract management functionality. As will be apparent to those skilled in the art, additional objects may be added to both the menus and the hierarchical tree in order to support the documentation of additional information and the expansion of functionality. Within the main menu 78, the menu structure for contract management module 22 preferably comprises at least the following functionality menus: Community Menu 80, Collaboration Menu 82, Commerce Menu 84 and Analysis Menu 86.

The Community Menu 80 groups together the communications functions. A communications area 88 desirably provides and supports conventional user communication tools such as Instant Messenger and email. A bulletin board area 90 allows users to post messages for all other users to view—similar to a community bulletin board. A global address book 92 provides users with the tools to maintain contact information. A research and reference area 94 is a collection of industry specific news articles and feeds, relevant Internet links, and research material.

The Collaboration Menu 82 groups together the functionality specifically related to contract management and collaboration. A contract list area 96 provides a comprehensive list of all contracts in the system that the specific user has permission to view. A contract line item number (CLIN) list area 98 allows users to create, read, update, and edit specific contract line items. A collaboration report area 100 provides a relational report of contracts and associated business objects.

The Commerce Menu 84 groups together the commerce and request-for-proposal (RFP) functions. A procurement area 102 is used to issue and receive orders. A sales area 104 allows users to monitor the sales that have been completed. An auction management area 106 serves as an area to conduct auctions for goods or services. The Ticker Setting area displays the items currently posted to the real-time ticker.

The Analysis Menu 86 groups together reporting and intelligent agent functionality. An Issue Item and Action Item (ISS/ACI) report area 110 provides reports based on specific sorts and filters, such as due dates, for Issue and Action Items. An intelligent agents area 112 is where intelligent agents are created, updated, and deleted. On the Internet, an intelligent agent is a program that gathers information or performs some other service without the user's immediate presence and usually on some regular schedule. Typically, an agent program, using parameters provided by a user, searches all or some part of the Internet, gathers information the user is interested in, and presents it to the user on a daily or other periodic basis. A standardized reports area 114 provides users with multiple options to analyze and view reports based on real-time information. A customized reports area 116 provides users with the tools to configure specialized reports that allow them to view the information in a manner that is conducive to completing the task at hand. An XML translation area 118 creates an XML version of business objects in the application.

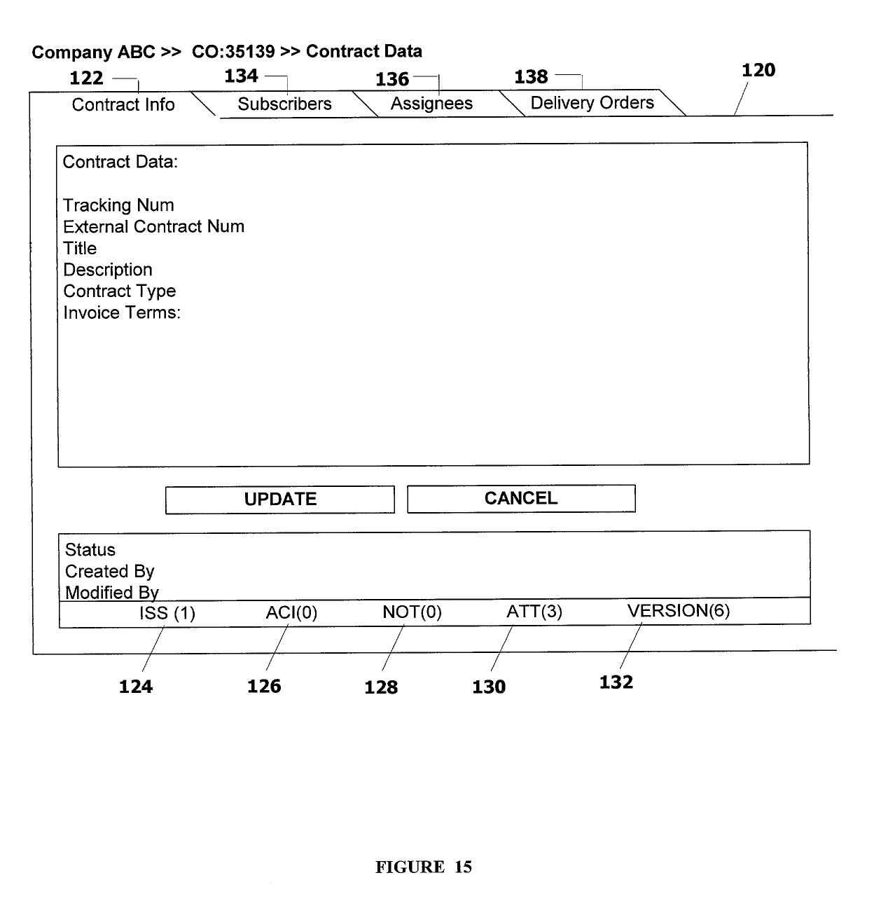

FIGS. 15-17 are diagrams of presently preferred generic graphical user interfaces (GUIs) that are utilized to capture and display information according to the present invention. FIG. 15 displays a tabbed interface page or screen 120 leveraged to capture several different screens of information related to a particular document in the system. The interface tabbed in FIG. 15 is the contract information for a hypothetical Company ABC for a particular hypothetical contract tracking number CO:35139. Related to the particular object that is being displayed (in this instance, for example, Contract Data), there are may be several visual indicators to notify the users of associated objects. For the Contract Info tab 122, these indicators may include such as Issue Items (ISS) 124, Action Items (ACI) 126, Notes (NOT) 128, Attachments (ATT) 130 and Version 132. Tabbed interface 120 may include other tabs for which other detailed information and other visual object indicators might be provided, such as, for example, subscribers tab 134, assignees tab 136 and delivery orders tab 138. For the exemplary screen 120 displayed in FIG. 15, there are one (1) Issue Items (ISS) 124, zero (0) Action Items (ACI) 126, zero (0) Notes (NOT) 128 and three (3) Attachments (ATT) associated with the screen object. And, the displayed Version information 132 information refers to the sixth version of the information on the screen, not the sixth version of the software of contract management module 22.

Issue Items, Action Items, Notes, and Attachments can be attached to any object in the system to which they are related. These collaboration tools are objects that are utilized to support the collaborative functions of contract management module 22 and serve as documentation for the tasks and discussions that occurred throughout the contract development process. Both Action Items and Issue Items can be created by any user in the system and can be assigned to users from the same organization or users from different organizations.

As mentioned above, an Action Item is used to capture, assign, and monitor specific tasks that need to be completed by a specific date. For example, if User 1 from Company A is working on a Contract with User 2 from Company B, and User 2 must provide some specific data, for example, verification of the term of the contract, then User 1 can create an Action Item, that is attached to the specific contract object, which outlines what tasks must be completed and assigns this Action Item to User 2. User 2 will be notified that he/she has been assigned a new Action Item by the system. Once the tasks are complete, User 2 will close the Action Item and it will remain associated with the Contract as historical data.

Again, Issue Items are utilized to request possible resolutions to outstanding problems or issues. For each Issue Item, several options can be captured and submitted back to the creator of the Issue Item.

A Note item is utilized to capture a user's comments on a specific object in the system. Notes provide a convenient and easy way to document comments about a specific field in an object or the entire object. By using multiple Notes, users have the functionality to carry on and document threaded discussions. Attachments are used to contribute additional information, in any format, to the process. For example, if a requirement is to build a specific object, such as an engine, the associated engineering drawings can be attached directly to the requirements form. This provides the user with the maximum flexibility in being able to contribute all of the necessary information assets to the process as well as being able to collect all of the relevant information in one space that is accessible to multiple enterprises and users.

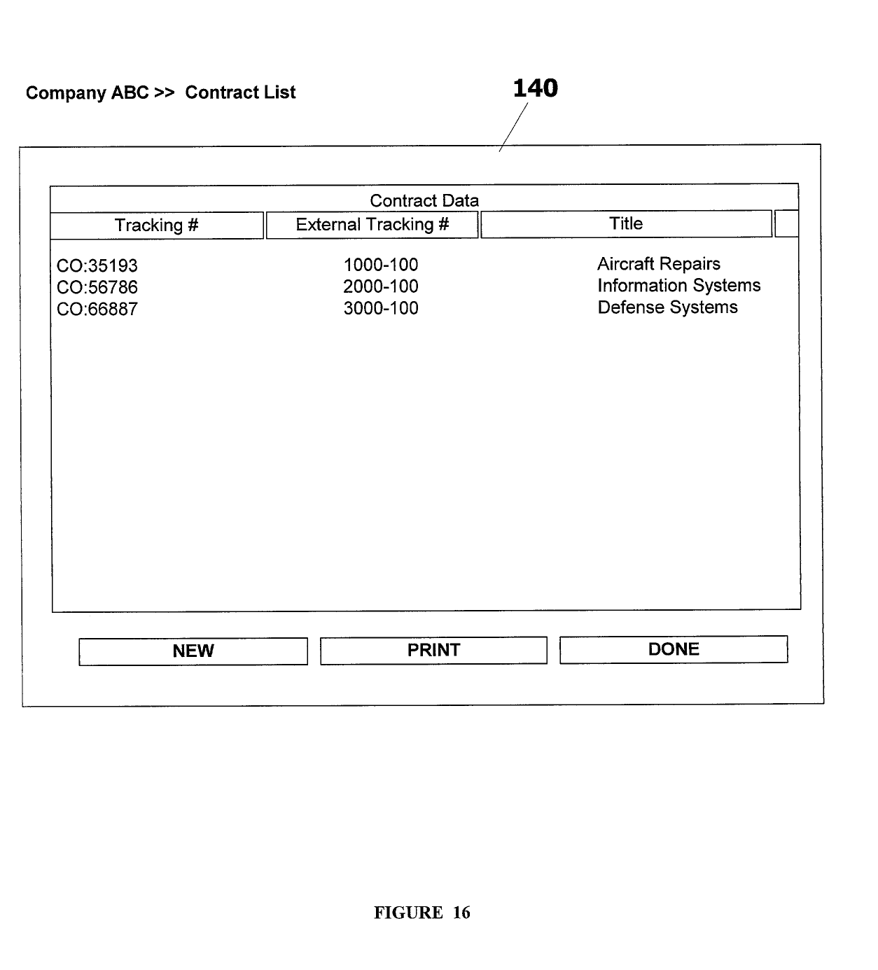

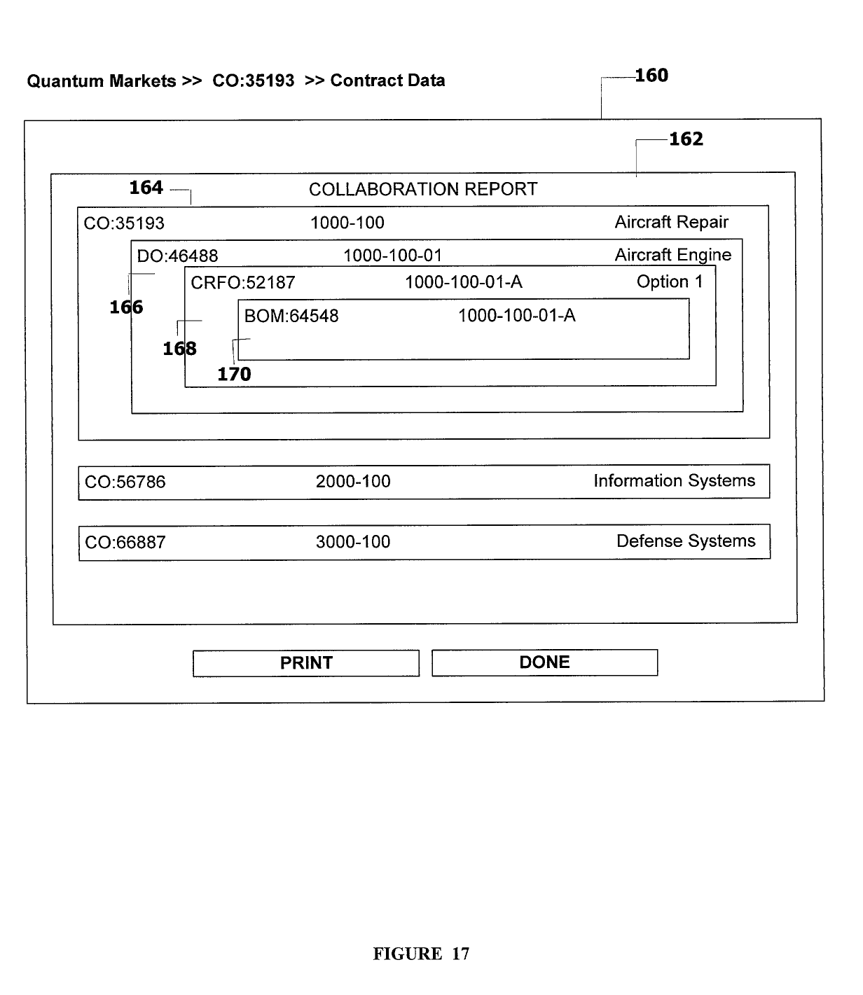

FIG. 16 displays a standard list page or screen 140 for easy access and availability of several objects of the same type, e.g., contracts. A similar type of screen may be made available for delivery order lists, purchase order lists or other contract-related objects that may be associated with individual contracts being tracked by the system. Each screen 120 (FIG. 15), 140 (FIG. 16) and 160 (FIG. 17) preferably includes a context sensitive menu, usually at or near the top of the screen that indicates where the list of objects is located within the hierarchy of the system.

FIG. 17 displays a typical detailed report page or screen 160 that enables the user to access all related objects at any level of the hierarchical tree. For example, a collaboration report 162 for a selected contract 164 having a contract tracking number CO:35139 for “aircraft repair” might include a delivery order 166 having a delivery order tracking number DO:46488 for an “aircraft engine.” Delivery order 166 might, in turn, include a certain customer requirements form option (CRFO) 168, e.g., Option 1, having a CRFO tracking number CRFO:52187 that involves a bill of materials (BOM) 170 having a BOM tracking number BOM:64548. It will be understood that similar collaboration reports exist for contract tracking numbers CO:56786 and CO:66887 that are also shown in FIG. 17 and any other contracts being developed and monitored by the present system. Those collaboration reports may be viewed by clicking on the desired contract tracking number which causes the report for that contract to be displayed in a manner similar to that shown in FIG. 17.

The following describes the major of the database model according to the present invention. The motivation and ideas behind the preferred design, the driving factors that led to the design, the key data elements and relationships of the database model are discussed. The major areas that have been modeled include: base objects and relationships, administration, permissions, secondary documents, statuses and custom fields.

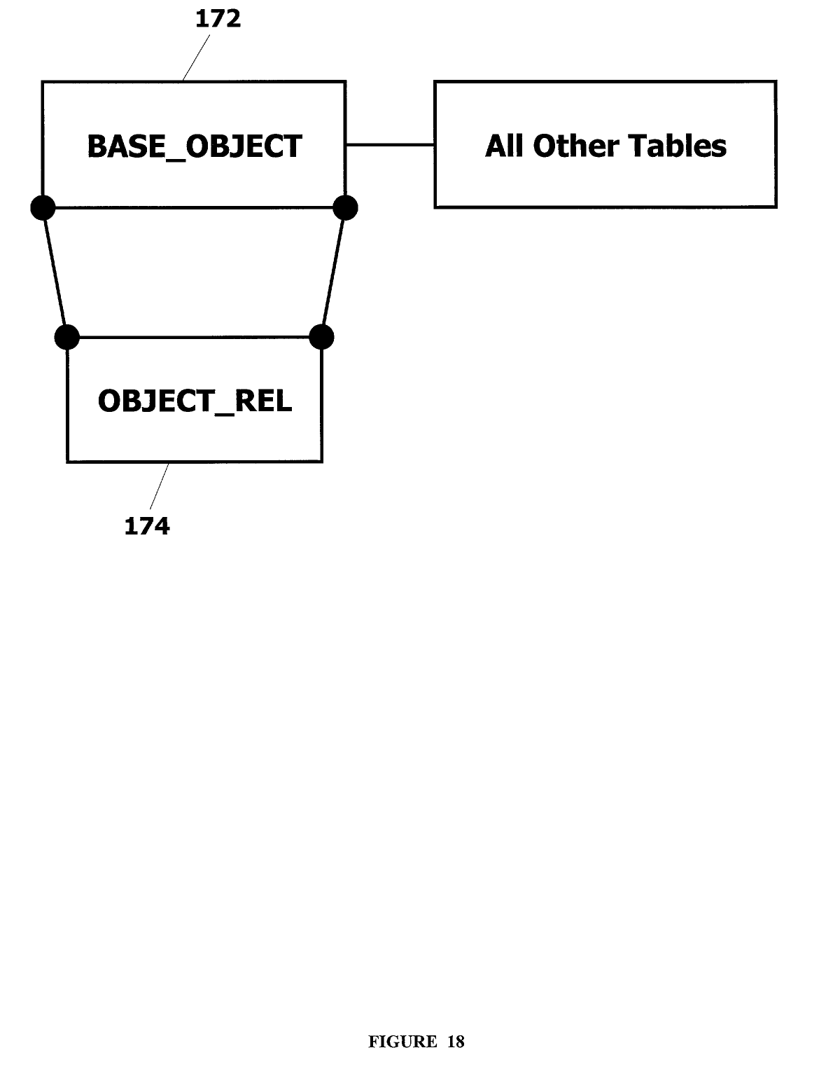

In the real world it is sometimes necessary to set up ad hoc relationships between entities. For example, one may want to capture a relationship wherein one subscriber is actually a department within another subscriber or that a supporting document is attached to a contract. In order to support these ad hoc relationships without having to constantly change the model, two tables were created and introduced: BASE_OBJECT and OBJECT_REL, as shown in FIG. 18.

As represented in FIGS. 18-21, a line connecting two drawing elements that has no solid circles on either end means that those elements are connected in a one-to-one relationship; a line connecting two elements that has a solid circle on one end means that those elements are connected in a one-to-many relationship, where the end with the solid circle represents the “many” and the end without the circle represents the “one”; and a line connecting two drawing elements that has solid circles on both ends means that those elements are connected in a many-to-many relationship.

The BASE_OBJECT table, identified by reference numeral 172 of FIG. 18, acts as a sort of parent table for all other tables in the system. The primary key field of all these other tables is also a foreign key to BASE_OBJECT table 172. That is, foreign keys to the BASE_OBJECT table are indirectly linked to any other table in the system. This relationship between keys has the following effects:

every table row in the system has a corresponding row in the BASE_OBJECT table;

primary keys are unique across all tables in the database, not just within tables; and

a table that has a separate foreign key to the BASE_OBJECT table (other than the already described primary key relationship) can potentially be linked to any other table in the system.

Since the BASE_OBJECT table is linked to all other tables, it is the place in which fields common to all objects (created_date, created_by_id, etc.) are placed. It also contains a TYPE field which helps identify which other table in the system contains the corresponding row of data. In object-oriented terms, the BASE_OBJECT table acts as a super class for the other tables in the system.

The OBJECT_REL table is the table that enables the creation of ad hoc relationships between objects. The following fields provide this functionality: OBJ1_ID, OBJ2_ID and REL_TYPE. OBJ1_ID and OBJ2_ID are both foreign keys to the BASE_OBJECT table described above, meaning they are indirectly linked to any other table in the system. The REL_TYPE field contains a descriptive string that allows us to distinguish the different types of relationships (i.e., attachment, department, and so forth) between objects. Note that it is possible to model almost all relationships in the database using this model. However, this table does not distinguish between the types of objects that are being linked to each other, so it is possible for relationships to be added that might not make sense (e.g., a contract might be identified as a department of a subscriber). Therefore, the use of this table should be limited. It is not used as a replacement for strict relational foreign key constructs. Its main use in the present system is for linking secondary documents described below to other tables in the system.

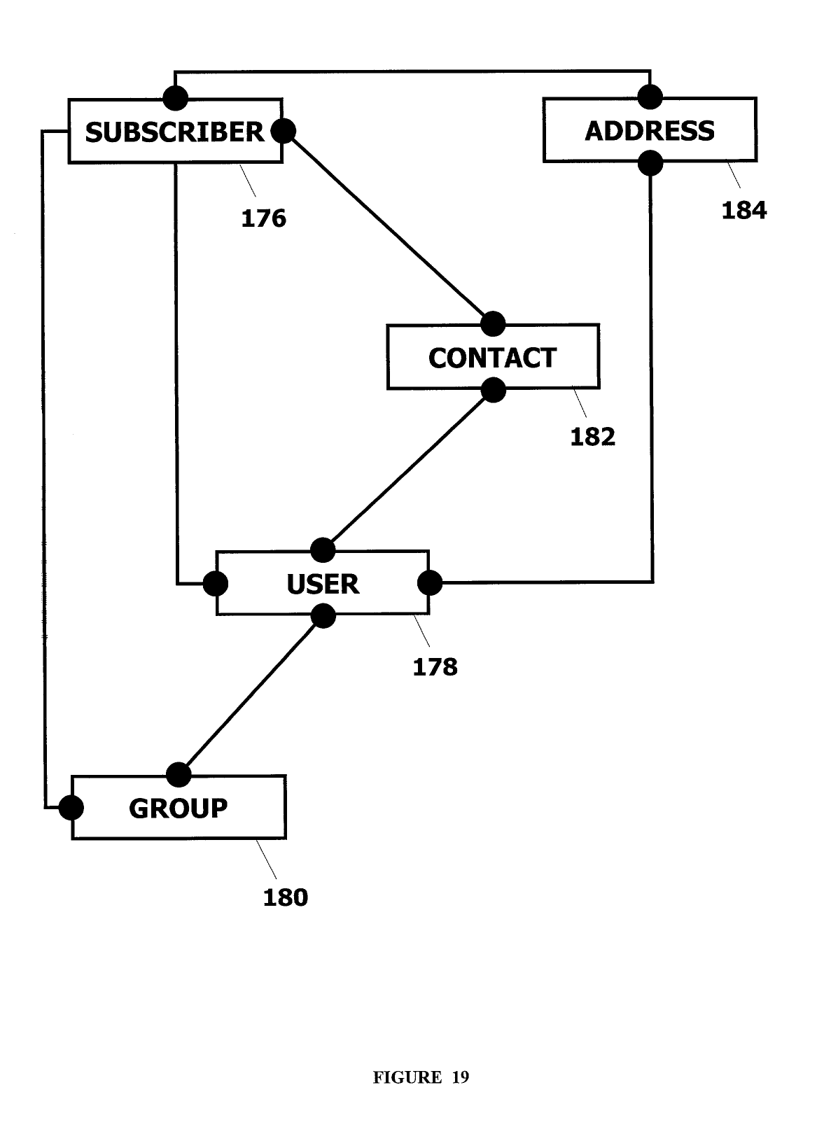

The Administration part of the system contains information describing the users in the system. As illustrated in FIG. 19, it contains the following sections: Subscribers, Users, Groups, Contacts and Addresses.

Subscribers 176 are the main grouping mechanism for users 178 of the contract management system according to the invention. Every user 178 belongs to one and only one subscriber 176. A subscriber will typically represent a business organization but doesn't necessarily have to. Subscribers 176 are also linked to other objects in the system and control business logic on those objects (i.e., contracts have a collection of subscribers denoting who the contract is between).

Users 178 are the entities who actually use the instant system. All access to the system is controlled via a user login. Every event that happens in the system is captured with the date and which user in the system performed that action.

Groups 180 are a way of creating an ad hoc collection of users 178. Every group 180 belongs to one and only one subscriber 176, but may contain any user 178 in the system. Groups 180 are used for many purposes such as mailing lists and object ownership.

Contacts 182 contain information on how to get in contact with entities in the system. Currently only users 178 and subscribers 176 have contacts. An example of a contact would be an email address, phone number, pager number, etc. Contacts 182 have a type field denoting which of these forms of contact information the contact is identified with along with a one line text field to hold the actual contact info.

Addresses 184 store the street or other physical addresses for users 178 and subscribers 176. Addresses are broken up into essentially two tables. An address table holds the actual street address information (street, city, state, zip, an so on) and a many-to-many join table links the address to a specific user 178 or subscriber 176 and contains type information for the address (home, work, headquarters, etc.). The join table allows an address 184 to be shared between multiple users 178 and subscribers 176 while allowing each entity to specify a unique type of physical contact address (i.e., an address may be the headquarters address for a subscriber 176, but a work address for a user 178 who is employed by the subscriber).

A secondary document is a piece of information that is attached to other entities in the database. It is essentially an object in the system (because its primary key is a foreign key to the BASE_OBJECT table), but it is treated differently by application code. Secondary documents have different types, with each type holding a different set of information. A currently preferred although not limitative list of types for the secondary documents are the aforementioned Action Items, Issue Items, Attachments and Notes.

Secondary documents are attached to the other objects in the system through the OBJECT_REL table 174 described above in connection with FIG. 18. Since they can be potentially linked to any other object (even other secondary documents), they clearly manifest the flexibility of the combination of BASE_OBJECT table 172 and OBJECT_REL table 174 described above. Also, the use of the OBJECT_REL table provides a many-to-many relationship allowing the same secondary document to be referenced by multiple objects in the system.

The contract management system of the present invention is a collaborative workspace where objects of different types are gathered for use by many parties. One of the goals of collaboration (especially in regard to government contracting situations) is the editing and review of an object until it reaches a state where all parties are satisfied with it. In order to capture the essence of “being satisfied” with the state of an object, the instant model introduces the notion of an approval. As discussed above, all parties collaborating on a given object are given the ability to signify that they approve of the state of an object. This approval is captured in an unillustrated OBJECT_APPROVAL table. Since it is possible for any type of object in the system to be collaborated on, the approvals are linked to the BASE_OBJECT table 172.

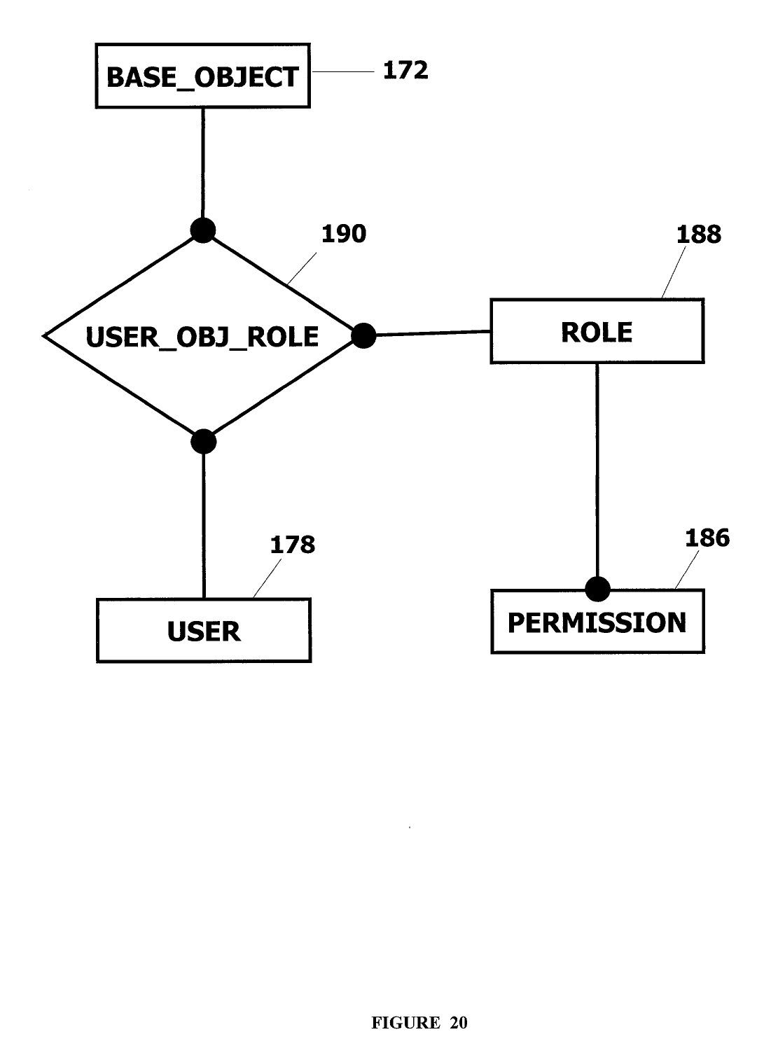

FIG. 20 is an entity-relationship diagram of participant permissions levels supported by the contract management system according to the invention. The purpose of the notion of permission is to capture what a specific user can and cannot do in the system. A particular permission is tied to a specific action performed within the system (create user, approve contract, etc.). A user 178 either can or cannot perform on or more of these actions. Permissions are inherently tied to objects, and a user is granted a permission on a specific object. For example, a user is not just granted a “create user” permission level. Since users 178 are created within subscribers 176, a “create user” permission is granted on a particular instance of a subscriber. This is similar to file system permissions where a certain user may be given read access on a file/directory, not a free floating read access.

PERMISSION 186: This table lists all the valid permissions in the system. In the present system, a permission is essentially a descriptive string defining a specific action.

ROLE 188: This table allows the grouping of permissions into logical sets. Permissions are not directly granted to users, rather they are grouped into roles, and roles are assigned to users. The main purpose of ROLEs 188 is to ease the management of permissions.

USER_OBJ_ROLE 190: This relationship table acts as the link between the user, object and role.

BASE_OBJECT 172: The link to BASE_OBJECT allows permissions to be applied to any object in the system.

USER 178: The user table described above.

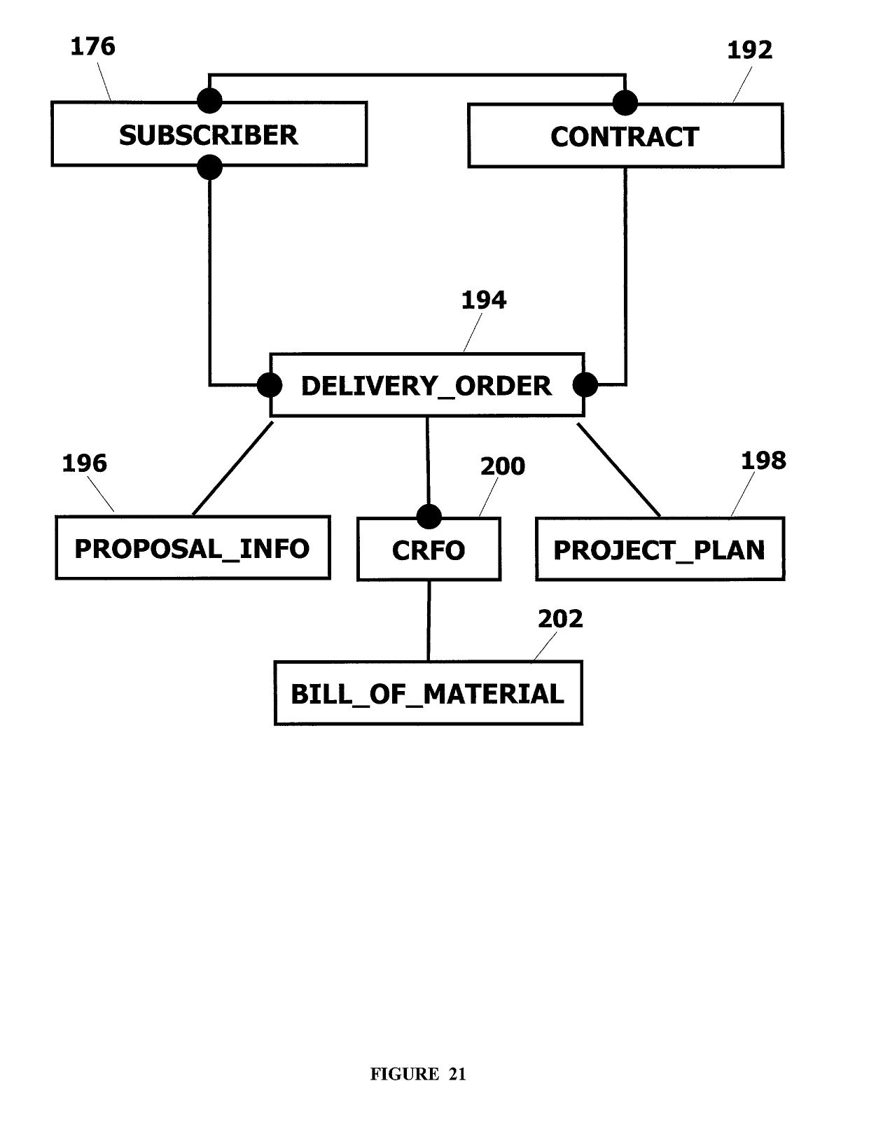

A major focus of the contract management module 22 application according to the invention is its ability to facilitate government contracting processes. FIG. 21 is the model that has been developed to support this focus.

FIG. 21 depicts a tree structure of documents used in a typical government contracting scenario. The root of the tree is the CONTRACT 192 representing an actual contract between organizations (subscribers 176). Under CONTRACT 192 there is the DELIVERY_ORDER 194 that is used for certain types of contracts to capture the transfer of products and services between participating organizations. Note that there is a many-to-many relationship between SUBSCRIBER 176 and both CONTRACT 192 and DELIVERY_ORDER 194. This captures the fact that a CONTRACT 192 may involve many organizations, but for each delivery order under the contract, only a subset of these organizations may be involved.

DELIVERY_ORDER 194 is a document that is actually composed of many subdocuments or sections. Some of these sections might include: PROPOSAL_INFO 196, PROJECT_PLAN 198 and CRFO 200, among other possibilities. PROPOSAL_INFO table 196 captures miscellaneous information about the delivery order when it is initially proposed. CRFO table 200 captures details on the customer requirements that need to be met upon successful completion of DELIVERY_ORDER 194. And PROJECT_PLAN 198 captures the detailed proposed schedule of the delivery of products/services.

The final element in the diagram is the BILL_OF_MATERIAL 202. This object is attached to the CRFO object 200 and captures the details of all the physical materials that will be needed to satisfy a specific requirement of DELIVERY_ORDER 194.

Contract management module 22 is preferably a Java-based web application. The standard API for building this type of application is the Java Servlet API. This API is very basic, and does not provide much in terms of functionality beyond basic interaction with the web browser. Because of this, contract management module 22 makes use of the Struts library or framework offered by the Apache software Foundation. Struts helps to better structure the contract management module 22 code so it follows the Model 2 design pattern for web applications. Contract management module 22 makes use of the following main Struts constructs:

Actions: Every request from a browser is converted to a Struts action. An Action class processes the request making calls to the other code modules.

Forms: Forms are data objects that hold a native Java representation of the parameters in the request. Actions use the data contained in Forms.

Forwards: Forwards are essentially URLs that Struts uses to determine what page to show to the user.

Mappings: A mapping is a combination of an Action, Form and a series of Forwards.

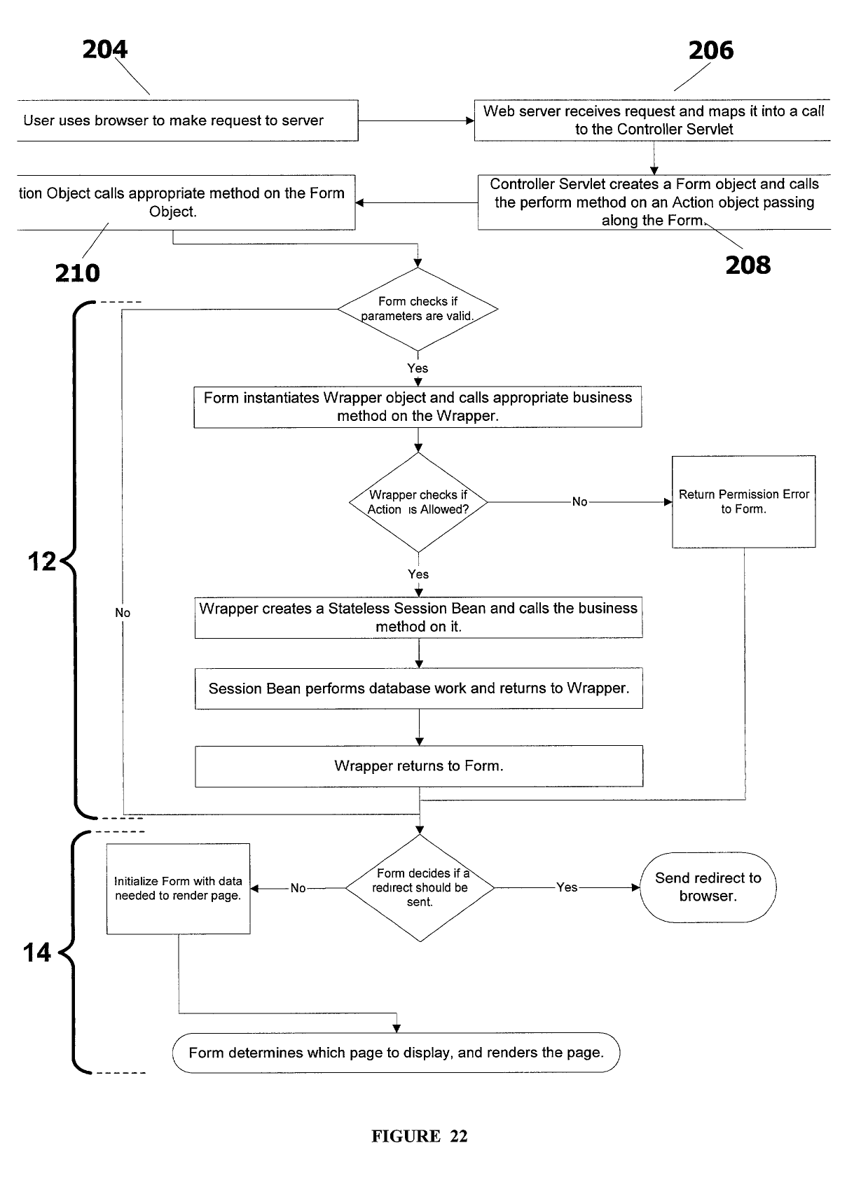

Referring to FIG. 22, the following steps describe the main flow from the browser into and out of Struts:

1. At 204, a user clicks link or presses a button on an HTML page causing an HTTP request to be sent to the server.

2. At 206, the web server receives request and maps it into a call to the Struts Controller Servlet.

3. Struts examines request and creates a mapping object based on the request URL.

4. The mapping object contains which type of Form object to create. At 208, Struts creates an instance of this Form object and fills it with data from the request.

5. The mapping contains which type of Action object to call to process the request. At 210, Struts creates an instance of the Action object and calls the Action object's perform method passing along the Form.

6. At 212, the Action object and Form object do their work by instantiating a Wrapper object and calling the appropriate business logic or method upon the Wrapper and, thereafter, creating an instance of a Forward object to return to Struts. The forward object is read from the mapping. At 214, based on the contents of the forward, a response is sent to the browser.

This flow is generally followed by contract management module 22 with some exceptions. In a typical Struts application, Action objects process the browser request by making calls to the other modules in the system, using the forms as a data object only. Contract management module 22 does not use Actions in this manner. In contract management module 22, there is only one Action class, identified herein as “BaseAction.” The main function of BaseAction is to forward control and processing of the request to the Form object that has been passed in, and to pass the Forward object returned by the Form back to Struts. The following are the steps taken by the perform method of BaseAction:

1. The Action makes sure the form is placed within the request.

2. The Action calls the prepare method on the Form.

3. The Action makes sure the user is logged into the system.

4. Based on request parameters, the page that was previously viewed by the user is placed at the top of the “history stack.”

5. Based on request parameters and an XML configuration file, the required business method is called on the form using Java's reflection API.

6. The business method of the Form performs its work and returns a Forward object to the Action. If the Form does not return a Forward, one of the following default Forwards is used:

a. The Forward on the top of the history stack is removed if the stack is not empty.

b. The Forward with the same name as the business method that was called is retrieved from the Mapping if the history stack is empty.

7. If there is an error during the processing of the Form, the Action class gives the Form an opportunity to handle the exception and take corrective action.

8. If the Forward returned by the form in step 6 points to a Java Server Page (JSP) page that need to be rendered now (i.e. it does not require a redirect to be sent to the browser), then the form is initialized for rendering.

9. If there is an error during the initialization in step 7 the Forward is set to render an appropriate error page.

10. The Forward is returned to the Struts Controller Servlet.

In Struts, Forms are mainly used for holding request data. In contract management module 22, Forms also contain the processing logic that makes use of the other modules in the system to perform the business logic of the request. There are many Forms in contract management module 22, but since many of them have similar functionality, a series of base Forms have been created from which all other Forms extend.

One of those Forms is identified herein as “BaseForm.” BaseForm is the Form that all other Forms descend from either directly or indirectly though intermediate Forms. It provides the following functions:

a default implementation of the methods needed for BaseAction to interact with all forms;

an initialization method with hooks for extending Forms. In programming, a “hook” is a place and usually an interface that allows a programmer to insert customized programming, e.g., an additional capability. Typically, hooks are provided for a stated purpose and are documented for the programmer;

a collection of variables that contain data common to all forms (i.e., the HttpRequest, the HttpResponse, the Mapping, the mode, etc); and

a series of utility functions that perform work based on set of common state variables (identified herein as findForward( ), isIncluded( ), isMode( ), etc).

All forms need to implement a set of methods in order for BaseAction to be able to interact with them. BaseForm provides default (and sometimes the only) implementations for most of the method hooks described herein. The following is a description of these methods:

Prepare( ): This is the first method called by BaseAction during request processing. It gives the Form the opportunity to do any initialization before the business method is called. By default, BaseForm initializes logging and other debugging aids.

CRUD business methods: CRUD stands for Create, Read, Update and Delete. These are the main methods implemented by all of the Forms in contract management module 22. Because these methods are so common, the BaseForm provides a default implementation.

“Cancel” business method: Cancel is another business method that is common to all Forms so BaseForm provides a default implementation therefor.

handleException( ): This is the method called on Forms to allow them to deal with error conditions reported to BaseAction. BaseForm provides a default implementation that displays a generic error message to the user.

findForward( ): This is the method that searches for an appropriate Forward object based on the current request processing. This is mainly a utility method as Forms do not override it. The method is instead parameterized to give it the flexibility to behave differently in different situations.

PostHandlers( ): This is a default implementation of the methods used to send notifications after an action is completed.

finish( ): This method is the last method called before BaseAction returns the forward to the Struts Controller Servlet. BaseForm provides a default implementation that undoes what was done in prepare( ).

If the result of processing an action results in the display of an HTML page (as opposed to sending a redirect response to the browser), the form that was created during the processing of the action must be initialized. During initialization, the Form loads data from the database (and other data sources) that will be used in the rendering of the page.

A key part of the initialization is the setting of the rendering “mode” the page will be in. The three main modes are display, edit and add. The following sections will discuss how each of these modes are determined and how the mode affects the rendering of the page.

In order to make sure that the initialization of all forms follows a uniform pattern, there is an initialize( ) method declared in BaseForm that is not overridden. This method provides method hooks that Forms can override to tie in specific initialization during the initialize( ) method. The steps implemented by this method in BaseForm are as follows:

1. Call a method hook to initialize the mode (display, add or edit). Note that the mode can also be passed in as a request parameter.

2. Based on the mode, call a method hook to initialize missing/required form parameters.

3. Call a method hook to validate that the current user is allowed (i.e., has permission) to view the page in the current mode. If not, set the mode to a level for which the user has access or deny access all together. p1 4. Based on the mode, call a method hook to initialize the entire form with the data that will be needed to render the page in that mode.

5. Call a method hook to initialize the form with data that is required regardless of the mode.

6. If the page is going to render the form, call a method hook to initialize the buttons that will be used to process the form.

BaseDataForm is the primary base class for all of the forms, which allow creating, reading and updating a business object. It extends BaseForm and provides the following functions:

It holds instance data for fields common to all objects in the system (this is analogous to BaseModel described above).

It implements the initMode( ) hook. The mode is set to either add/edit/display based on the information in the request and the permissions of the user. For example, if no ID is given, Add mode is assumed and a Create permission is checked on the parent object. If an ID is given, the mode is set to Edit if the user has Update permission on the object or Display if the user does not have Update but does have Read permission.

And, it provides a default implementation of the Create, Update and Delete business methods by making calls to Form-specific Wrapper classes. Method hooks are used here also for the purpose of obtaining a Form-specific Wrapper and converting the Form data fields into a Model class used by the Wrapper. The Forms that extend BaseDataForm need to implement the hooks if they do not override these methods themselves.

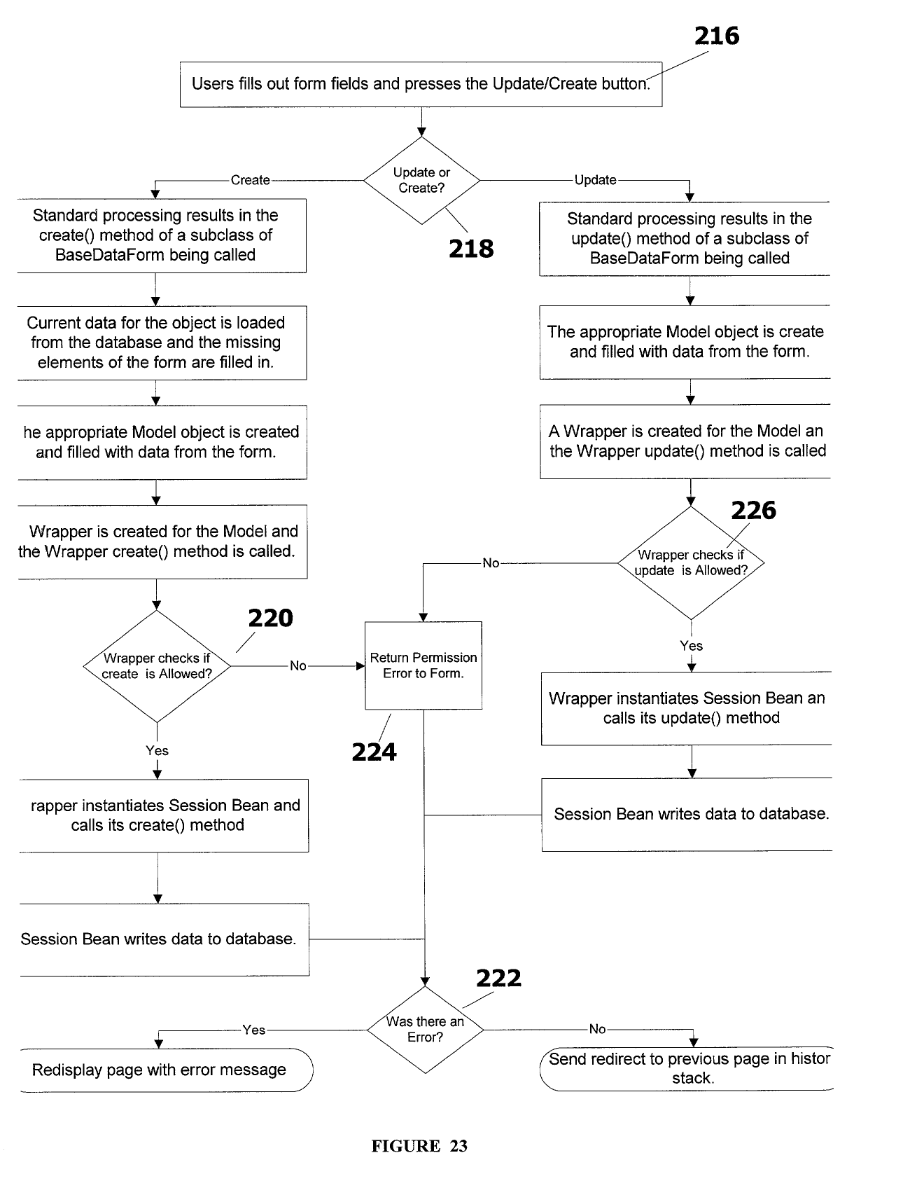

FIG. 23 is a data page flow diagram through certain of the software layers of the contract management system according to the invention. At step 216, a user fills out form fields and presses or clicks a GUI Update/Create button associated with the form. At 218, contract management module 22 determines if the form is being filled out for the first time (or “created”) or if it is a revised (or “updated”) version of earlier information that has been submitted by the user. If the form is being “created”, a create( ) method subclass of BaseDataForm is called and current data for the object is loaded from the database and the missing elements of the form are filled in. Thereafter, the appropriate Model object is created and filled with data from the form. A Wrapper is then created for the Model and the Wrapper create( ) method is called.

At step 220, the Wrapper checks if “create” is allowed. If the answer is yes, the Wrapper instantiates a session bean (EJB), calls the session bean's create( ) method and the bean writes the “create” data to the database. At step 222, the system determines if there was an error in the process: if there was, the system redisplays the page with an error message; if there wasn't the system sends a redirect to a previous page in the history stack. If the answer is no at step 220 (i.e., whether the “create” action is allowed), the system, at step 224, returns a permission error to the form and step 222 is repeated and the actions described above in respect to the presence or absence of an error are executed by the system.

If the form is being “updated”, an update( ) method subclass of BaseDataForm is called, the appropriate Model object is created and filled with data from the form. A Wrapper is then created for the Model and the Wrapper create( ) method is called.

At step 226, the Wrapper checks if “update” is allowed. If the answer is yes, the Wrapper instantiates a session bean (EJB), calls the session bean's update( ) method and the bean writes the “update” data to the database. At step 222, the system determines if there was an error in the process: if there was, the system redisplays the page with an error message; if there wasn't the system sends a redirect to a previous page in the history stack. If the answer is no at step 226 (i.e., whether the “update” action is allowed), the system, at step 224, returns a permission error to the form and step 222 is repeated and the actions described above in respect to the presence or absence of an error are executed by the system.

Continuing, the system according to the invention further preferably includes a BaseListForm. The BaseListForm is the primary base class for all of the forms which list similar business objects. It extends BaseForm and provides the following:

a collection of objects to be iterated over;

a default implementation of checklist( ) to remove objects if a user is denied read permission;

an array of object identifications selected from the collection by the user to perform some Action on;

validation that this array is not empty;

default actions for Print (which displays selected items in a printable format), Create (which takes the user to the appropriate DataForm), and Cancel (which returns the user to the previous page); and

a list of buttons corresponding to the default Actions.

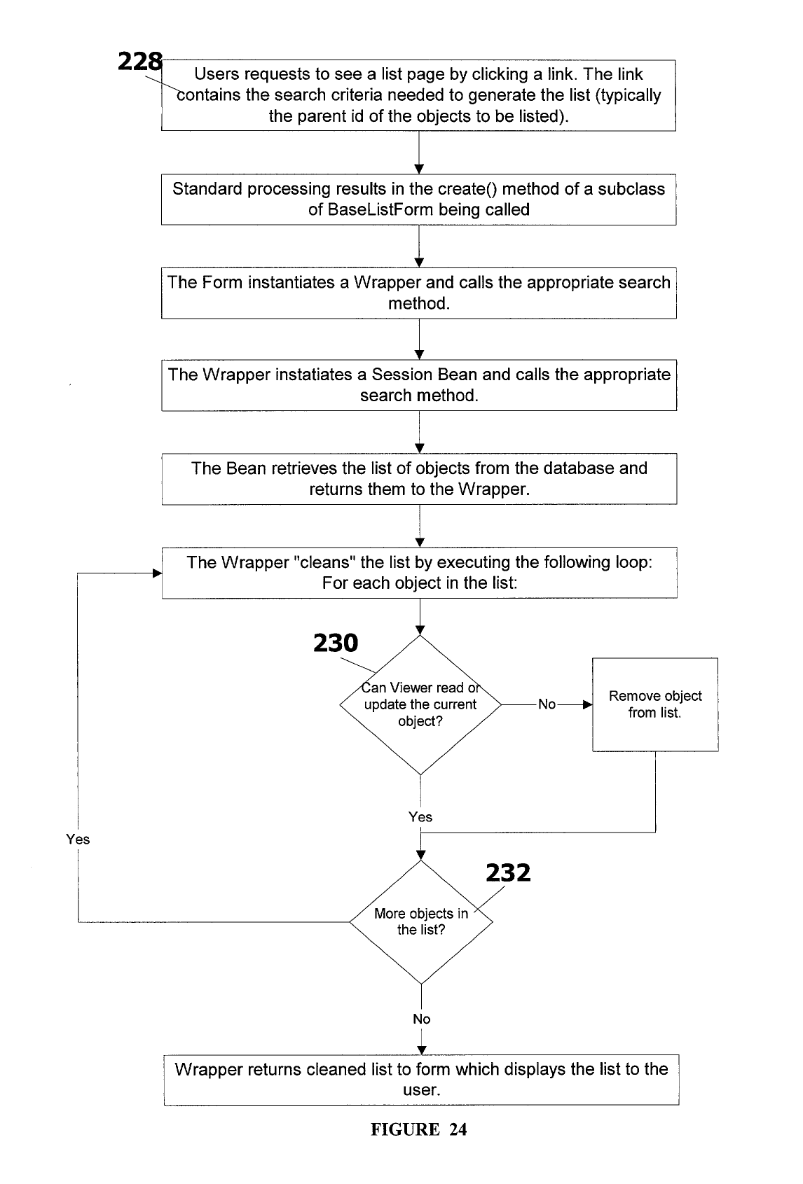

FIG. 24 is a list page flow diagram through certain of the software layers of the contract management system according to the invention. To initiate the flow, at step 228, a user requests to see a list page by clicking on a link that contains the search criteria needed to generate the list. This in turn results in the create( ) method of a subclass of BaseListForm being called. Thereafter, the Form instantiates a Wrapper and calls the appropriate search method. The wrapper then instantiates a session bean and calls the appropriate search method. The session bean retrieves the list of objects from the database and returns them to the Wrapper and the wrapper “cleans” each object in the list according to the following:

At step 230, the Wrapper inquires whether the viewer can read or update the current object. If the answer is yes, it asks, at step 232, whether there are more objects in the list. If the answer is no at step 232, the wrapper returns the cleaned list to the form which displays the list to the user. If the answer is yes at step 232, the wrapper returns to and repeats steps 230 and 232 until the answer at step 232 is no, at which time the wrapper returns the cleaned list to the form which displays the list to the user.

If the answer is no at step 230, i.e., the viewer cannot read or update the current object, the object is removed from the list and the subsequent objects in the list are analyzed by the Wrapper in the manner described until the Wrapper returns the cleaned list to the form for display by the user.

The system according to the invention further preferably includes a BaseJoinForm. The BaseJoinForm is the primary base class for all of the forms which allow a relationship to be created or removed between one primary object and multiple related objects at one time. It extends BaseForm and provides the following:

a collection of objects, which have the specified relationship to the primary object, and an abstract method for populating this collection;

a collection of objects that may be but are not currently related to the primary object, and an abstract method for populating this collection;

an array of identifications that represent the user's choice of objects to have a specific relationship;

permission checking to ascertain whether a user can create or remove relationships and which objects the user is allowed to make these changes between;

a method which creates and removes the appropriate relationships; and

a list of buttons for display.

All objects in the system have a variable number of statuses that can be attached to them. Because the statuses are all attached in the same way (using the BASE_OBJECT concept), there is a single page that is included on data pages to handle all of the different statuses. Although not illustrated, such page preferably assumes the general “look and feel” of the windows or screens shown in FIGS. 15-17.

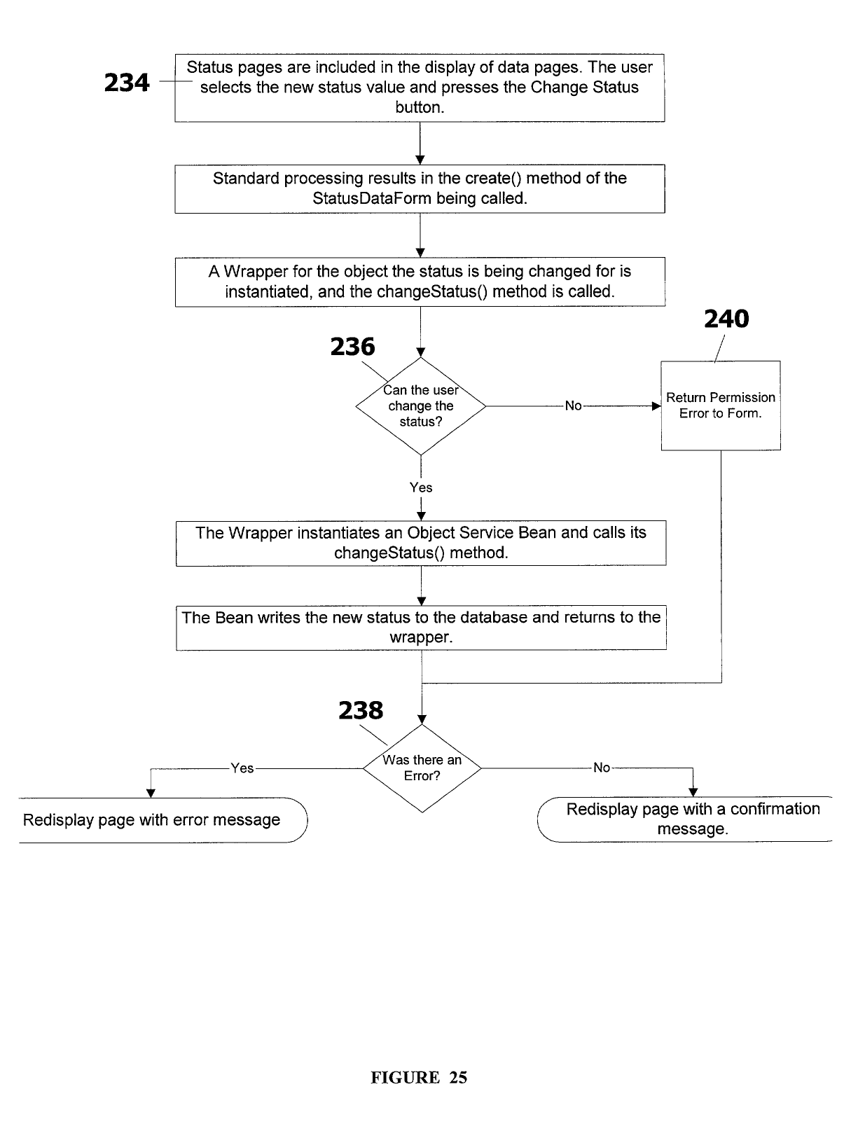

FIG. 25 is a change status (approval) flow diagram through certain of the software layers of the contract management system according to the invention. Status pages are included in the display of data pages. As seen in FIG. 25, to initiate the flow, at step 234, a user selects the new status value and presses or clicks on a Change Status button. This results standard processing within the present system calling the create( ) method of the StatusDataForm being called. A Wrapper for the object whose status is being changed is then instantiated and a changeStatuso method is called.

At step 236, the Wrapper determines whether the user can change the status of the object. If the answer is yes, the Wrapper instantiates an object service bean, calls the bean's changeStatus( ) method and the bean writes the “new status” data to the database. At step 238, the system determines if there was an error in the process: if there was, the system redisplays the page with an error message; if there wasn't, the system redisplays the page with a confirmation message. If the answer is no at step 236 (i.e., whether the “status change” action is allowed), the system, at step 240, returns a permission error to the form and step 238 is repeated and the actions described above in respect to the presence or absence of an error are executed by the system.

According to a presently preferred embodiment of the invention, there are two types of page flow in the system: directed and history based. Directed flow simply means that the action the user takes directly determines the page that is displayed. For example, in a directed flow, the user may click a CRFO link or press the “Create New” button on the Contract List page. These actions require a specific page to be rendered. Some actions, however, do not result in a specific page being rendered; these are history based flows. For example, a user may hit the cancel button on the “Create Action Item” page. For actions such as this, the page to render is determined by the business logic of contract management module 22 by asking “where did the user come from.” Essentially, if there is no specific page to go to, the user is taken to a page he or she had viewed previously. The pages a user has visited are tracked by the instant system by a “history stack.” The history stack is maintained by noting where the user came from when they perform an action resulting in a directed page flow. The page the user was on when the directed flow happens is pushed onto the top of the stack. Then, when a history based flow is requested, the page on the top of the stack is removed and that page is rendered again. Note that the user's browser's built-in history record cannot be used for this as it sees all requests as forward moving requests. It does not have the ability to distinguish between directed and history based movements since this is a concept in contract management module 22.

In accordance with the presently preferred Java 2 Platform, Enterprise Edition (J2EE), much of configuration described herein is abstracted into XML documents to increase the flexibility and accessibility of the system. The URLs that control the flow and determine the hyperlink targets are defined in this manner allowing Page Flow and Navigation to be configured without code changes by those familiar with XML. Due to the dynamic nature of contract management module 22 it was necessary to also provide a mechanism to allow the population of http request parameters from this XML. A class identified herein as ParamForward provides a very flexible way to retrieve values from a number of objects using introspection and to specify request parameter names. The following example illustrates how the XML element defines were the “data” link should take the user from the contact list page.

<forward name=“data”

path=“contactdata.do?id=$userId=$&amp;subscriberId=$”

redirect=“true”/>

In addition to specifying the contactdata.do URL, this element informs the Controller Servlet to add the parameter “id” (identification) and set it equal to the value stored in the field userId in the current Form Object and add the parameter subscriberId and set it equal to the value stored in the field subscriberId in the current Form Object. Finally, it specifies that request should be sent back to the browser to be redirected to this URL.

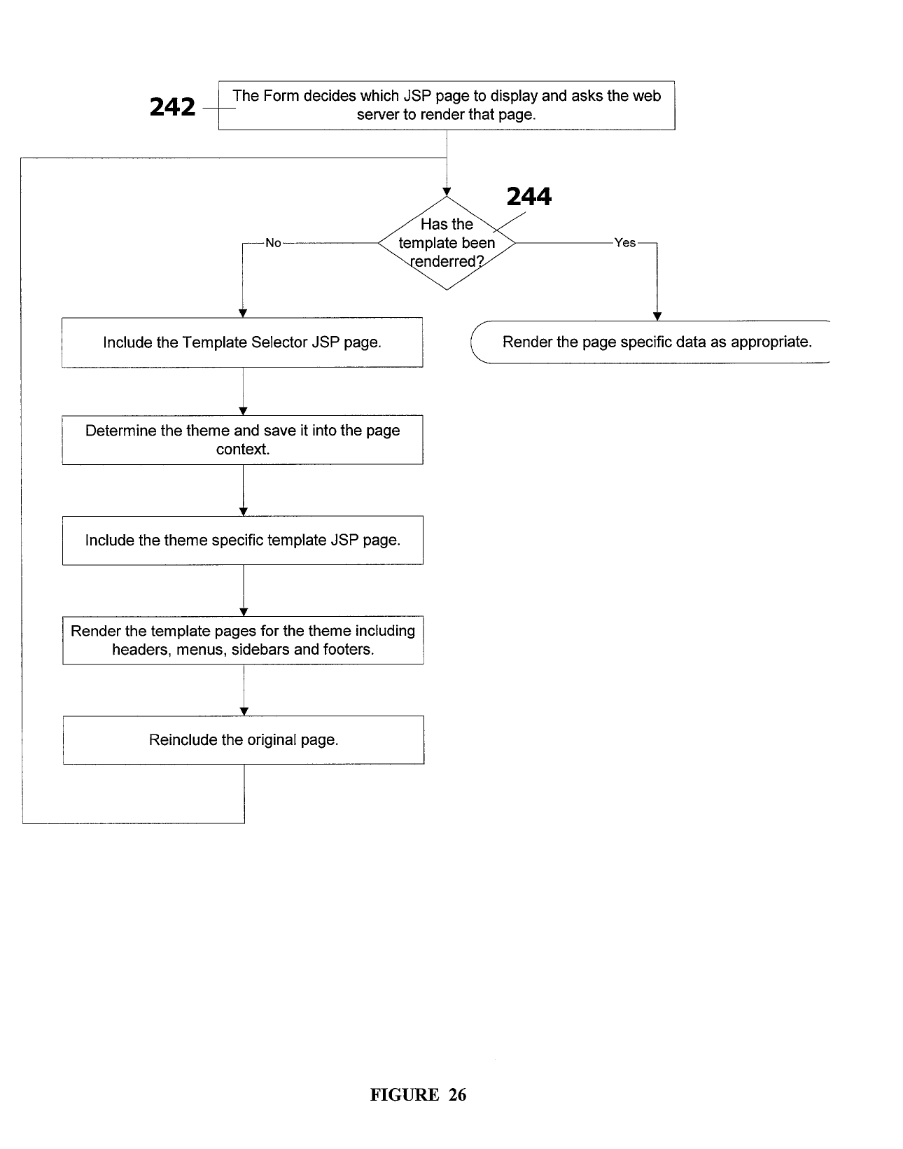

HTML pages in contract management module 22 are all rendered in a similar manner. FIG. 26 is illustrative. It is a flow diagram demonstrating how the contract management system according to the invention renders a generic web page that is viewable by a user. To initiate the flow, at step 242, the form decides which JSP page to display and asks the web server to render that page. At 244, the system queries whether the template has been rendered. If the answer is yes, the page specific data is rendered as appropriate. If the answer is no, the template selector JSP page is rendered and the theme of the template is saved into the page context. Thereafter, the theme-specific template page is read and the template pages for the theme (including headers, menus, sidebars and footers) are rendered. The original page is then reread and the page specific data is rendered as appropriate.

The template creates the basic layout of the page including top and bottom menus, cascading style sheets (CSS), and common client side scripts. Pages can be rendered with or without a template. This allows any page to be viewed as a standalone page or as an included section within another page. The template only needs to be rendered once for all included sections in the same page.

The flexibility of included pages is similar to the use of widgets in portal sites. A “widget” (also referred to as a portlet) is a GUI component driven by parameters. These included pages can be reused throughout the site in areas that require common front-end functionality.

Each Page that is sent to the browser to be rendered has a Mode which describes how the data is to be displayed and which actions the user can take. Depending on what kind of data and type of page is to be displayed, there can be several modal possibilities that may be chosen: add, edit, display and print. Each Form determines the mode it is in, checks to see if it has the required parameters for that mode and, using those parameters, validates the mode based on permissions and chooses the appropriate JSP to display.

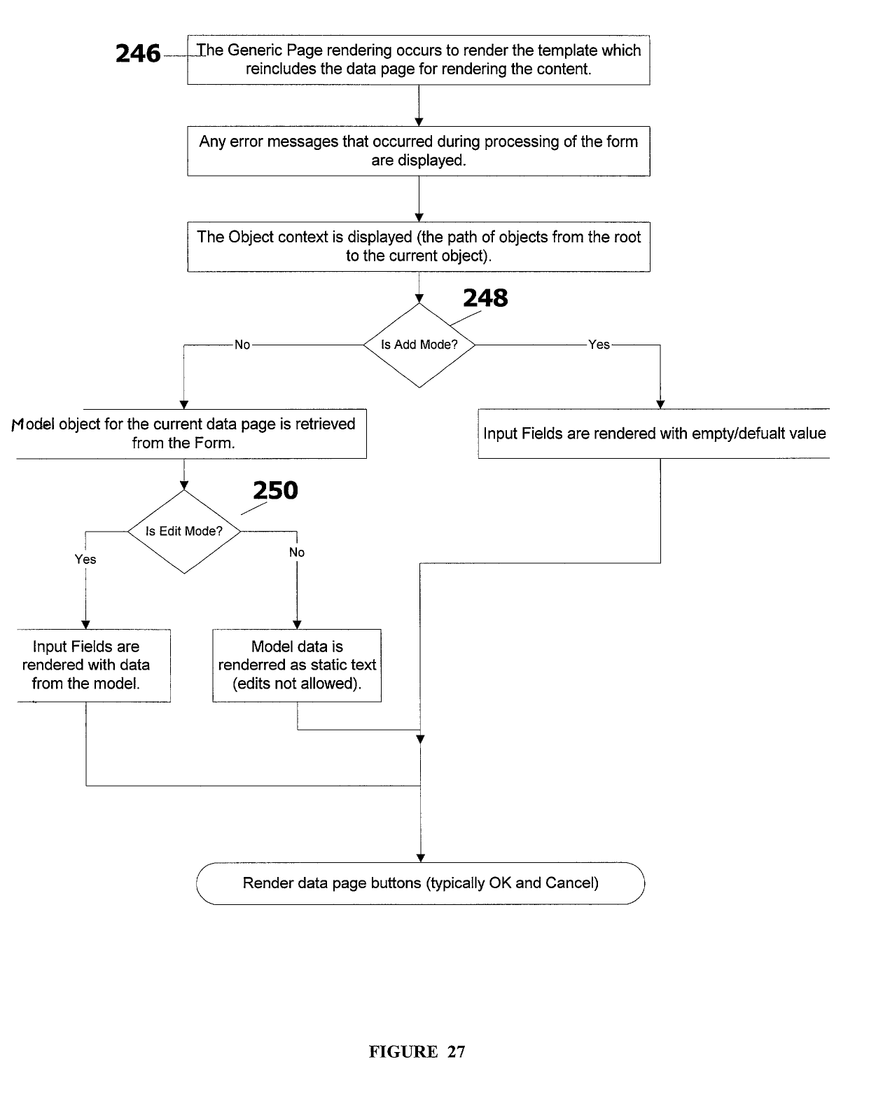

FIG. 27 is a flow diagram demonstrating how the contract management system according to the invention renders a data page that is viewable by a user. Data pages are analogous to forms that extend BaseDataForm and provide an interface for the user to create, edit or read the data associated with an object in the system. To initiate the flow, at step 246, the generic page rendering process described in connection with FIG. 26 first occurs in order to render the template which reincludes the data page for rendering the content. Following this, any error messages that occurred during processing of the form are displayed. The object context is then displayed, i.e., the path of objects from the root to the current object.

At step 248, the system determines whether the page is in the “add” modality. If the answer is yes, input fields with empty/default values and data page buttons such as OK and Cancel are rendered. If the answer is no, the Model object for the current data page is retrieved form the Form. At step 250, the system determines whether the page is in the “Edit” modality. If the answer is yes, input fields with data from the model object and data page buttons are rendered. If the answer is no, model data is rendered as static text (i.e., wherein edits are not permitted) and the data page buttons are rendered.

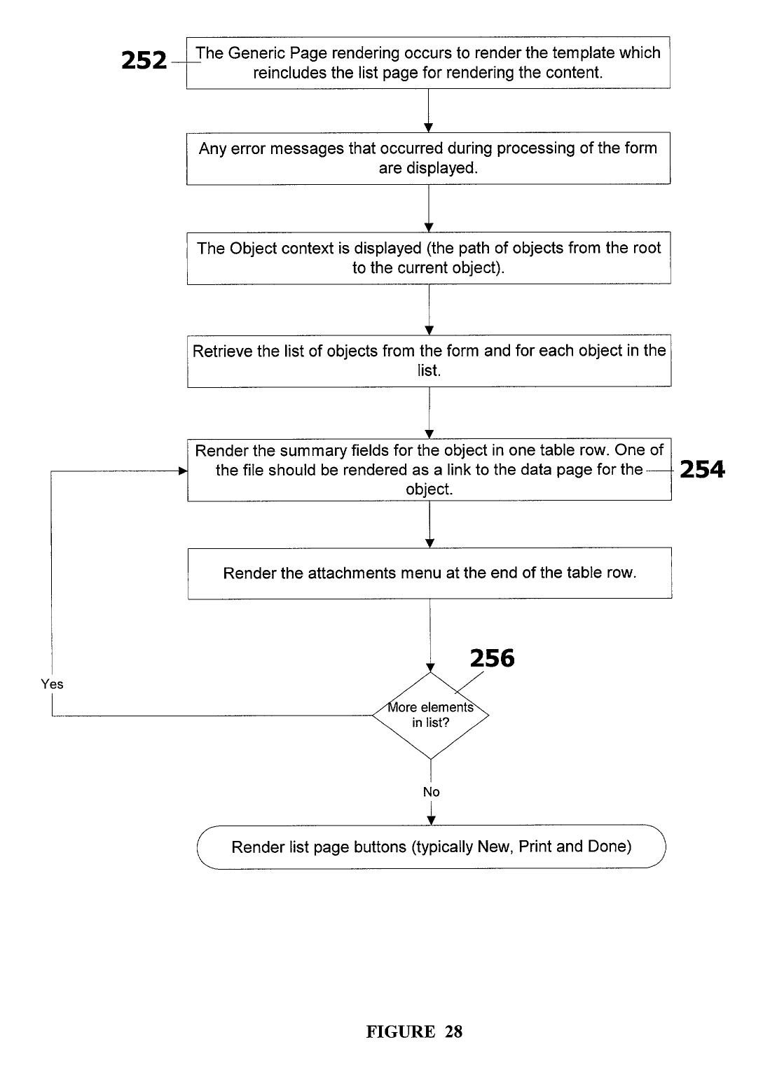

FIG. 28 is a flow diagram demonstrating how the contract management system according to the invention renders a generic list web page that is viewable by a user. List pages are analogous to forms that extend BaseListForm and provide an interface for the user to view a list of objects that match a particular search criteria. To initiate the flow, at step 252, the generic page rendering process described in connection with FIG. 26 first occurs in order to render the template which reincludes the list page for rendering the content. Following this, any error messages that occurred during processing of the form are displayed. The object context is then displayed, i.e., the path of objects from the root to the current object. The list of objects form the form and for each object in the list is then retrieved.

Thereafter, at step 254 the summary fields for the object are rendered in one table row. One of the fields should be rendered as a link to the data page for the object. And, the attachments menu is rendered at the end of the table row. At step 256, the system asks whether there are more elements in the list. If the answer is no, the appropriate list page buttons are rendered (typically New, Print and Done). If the answer is yes, steps 254 and 256 and the intervening attachments rendering step are repeated until all elements in the list have been processed.

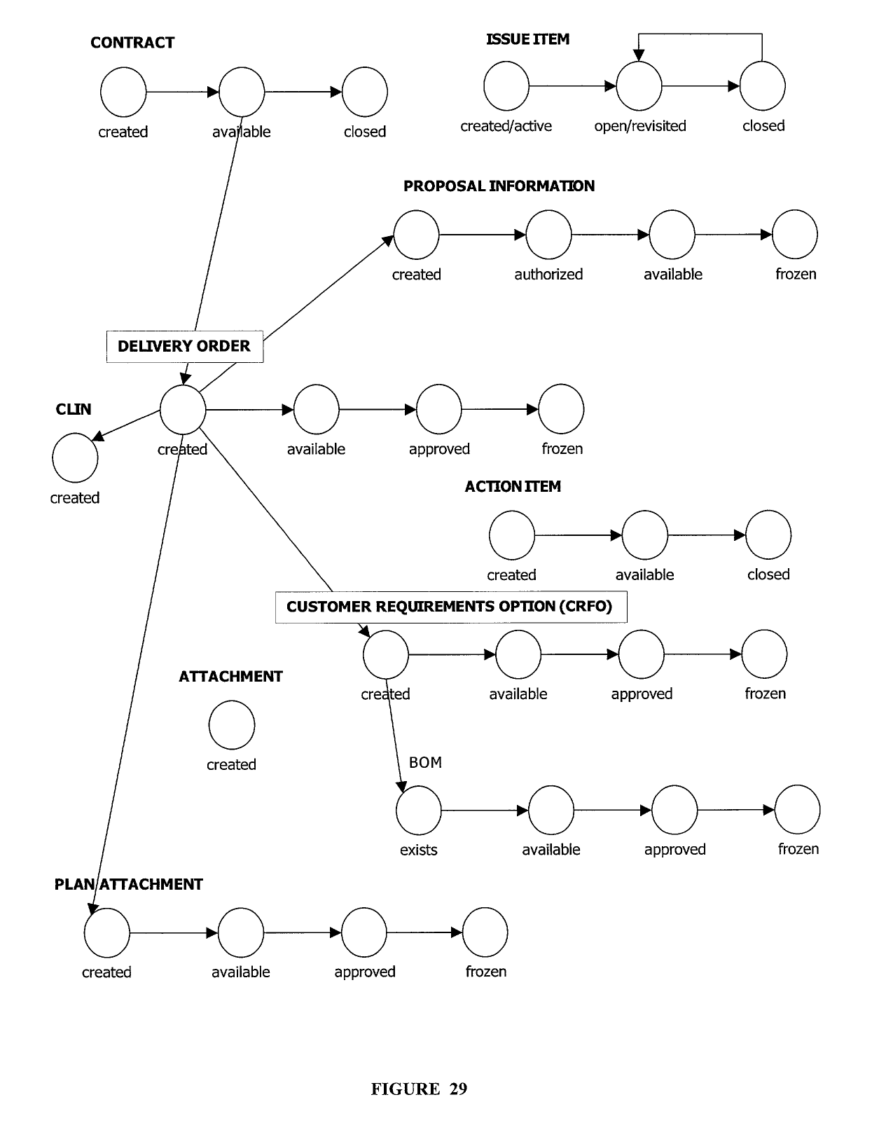

All objects in contract management module 22 are considered to be in a particular “state” at any given moment. The state is not directly stored but is derived from the events that have occurred on the object. This can be viewed as all objects in the system have an associated state transition diagram, with the nodes in the diagram being the states, and the events are the arrows joining the nodes. A typical example of such an object states diagram is shown in FIG. 29.

As seen in FIG. 29, a bill of materials (BOM) may be associated with a CRFO and may exist in several states during the contracting process, i.e., “exists”, “available”, “approved” and “frozen.” The CRFO itself may be associated with a delivery order and may exist in several states during the contracting process, i.e., “created”, “available”, “approved” and “frozen.” The delivery order, in turn, may be associated with a particular contract and may also exist in the states of “created”, “available”, “approved” and “frozen” during the contracting process. The contract itself may exist in the states of “created”, “available” and “closed.”

Currently with its association with the CRFO object, the delivery order object may also be associated with other objects each having their own possible states of existence during the contracting process. For example, the delivery order might also cause the generation of proposal information that may exist in the states of “created”, “authorized”, “available” and “frozen”, a CLIN existing in the state of “created” and a plan attachment that may exist in the states of “created”, “available”, “approved” and “frozen.”

Certain other collaboration tool objects, such as issue item, action item, attachment and notes (not illustrated) may be associated directly or indirectly with any object of a particular contract or, as illustrated, they may be “free-floating”, i.e., not-related to a contract. Attachments (and notes) may exist in the state of “created.” An action item may exist in the states of “created”, “available” and “closed.” And, an issue item may exist in the states of “created/active”, “open/revisited” and “closed.”

The main reason that states are not stored directly is that the state of an object may be affected by the states of other objects it is related to in the system. An example of the relationships that exist in contract management module 22 can be seen in the government contracting context. In that context, when a delivery order moves from a “shared” state to a “reviewed” state, all the objects below the delivery order transition into a “frozen” state.

Object states are also important in that they are used extensively in permission checking. Permission checking is the act of determining whether or not the current user can perform a requested action on an object. It is important to note that all actions in contract management module 22 are performed on objects. Thus, permissions are inherently tied to objects. In contract management module 22, a permission is checked using two pieces of information: the granting of the permission to the user on an object in the DB and the current “state” of the object being acted upon. An important point to note is that like state, the granting of a permission is determined not only by examining the object itself but also the objects it is related to in the system. For example, the permission “update_crfo” can be granted to a specific instance of a CRFO, but it also may be granted to a delivery order. When it is granted to a delivery order, it is the same as saying “the user is allowed to update all CRFOs that are attached to this delivery order.” This concept makes the granting of roles and permissions on objects easier to maintain.

According to the preferred embodiment, the arrangement or graph of related objects that determines an object's state is considered to be the same graph as that which determines the granting of a permission. This allows for a straightforward implementation of permission checking tracks this graph checking simultaneously for object state and permission granting.

Interface module 28 uses the underlying MOM mechanism of a JMS server to pass predefined formats of standard objects of contract management module 22 in XML format. The preferred embodiment of the invention utilizes the SonicMQ® messaging application available from Progressive Software Corporation as the JMS server. The interface module 28 allows for the administrator of the contract management module application to link transmissions based on event processes defined in the contract management module, set routing and integration procedures, and define security settings for the contract management module relative to other contract management module installations. The JMS Server enables Secure Socket Layer (SSL), queuing management, tracking and logging, load balancing, and fail-over. In addition, the JMS Server facilitates numerous communication techniques including synchronous and asynchronous communication, publish/subscriber functionality, point-to-point communication, filters, and adapter management. The communication techniques chosen, or communication actions, are a function of how the event is characterized by the event processor.

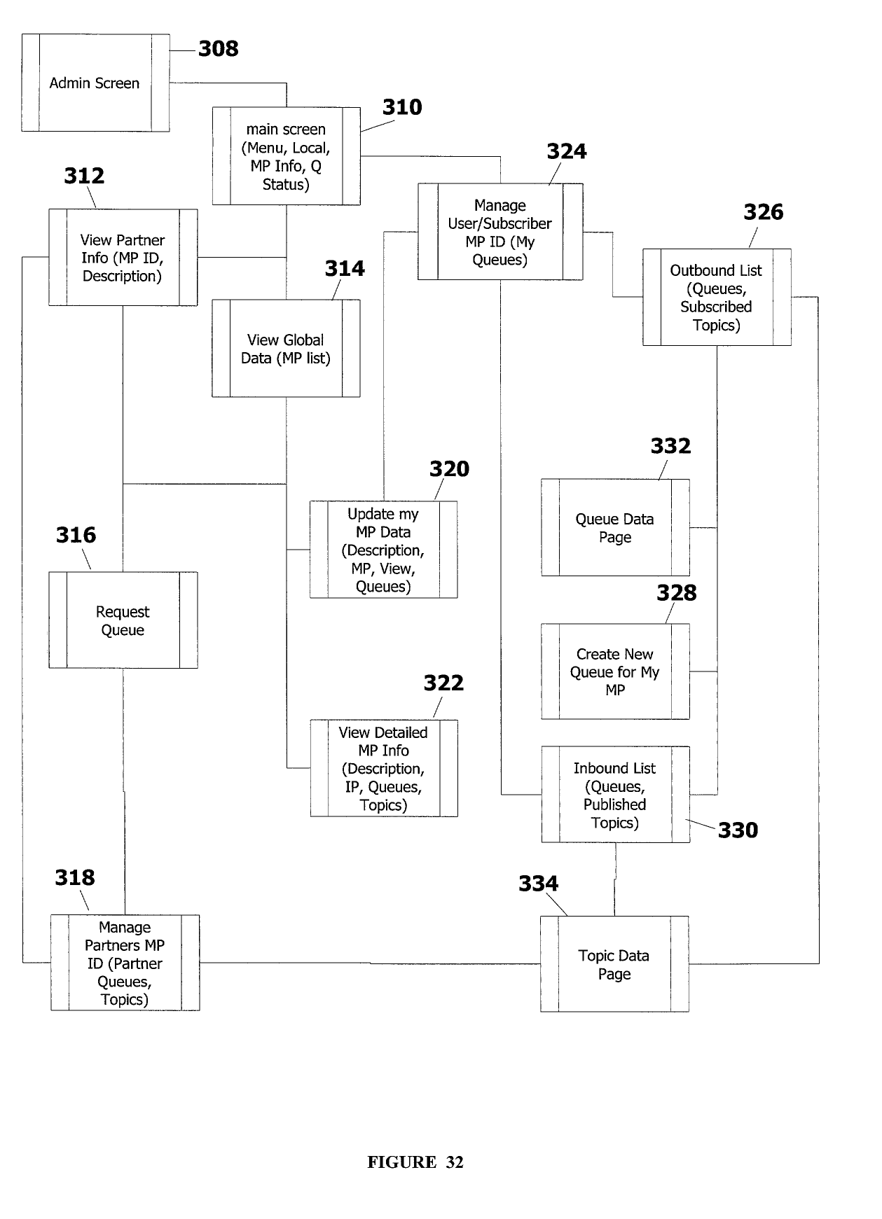

In order to support the OpenWeb infrastructure on which interface module 28 is based, an addressing schema is required. A Global Application Addressing Method (GAAM) was developed as part of the present invention to facilitate this functionality This method is exemplified in FIG. 32 and utilizes marketplace identifiers or MPIDs 258 in place of or as synonyms for domain names and/or IP addresses. GAAM also provides an application address for each business object in the system. This address is compiled using application information that includes the contract management module 22, Subscriber ID 260, contract management module 22, UserID 262, the business object type 264 and the business object identifier 266.

In the illustrated example the GAAM address will be 0190:0012:2775:CRF034890. This address can be used to access application data by contract management module 22 or any other application with the appropriate security clearance to access the business object residing at that GAAM address. The GAAM address uses conventional address identifiers such as a domain name synonym 268 and an IP address 270 and its related port 272, directory 274 and file 276 but then extends that address to access data elements within specific applications.

Contract management module 22 recognizes defined gates or events, such as the posting of data to the database, which constitute noteworthy changes in the state of the system. When these events occur certain standard actions are triggered. Actions include the population of data onto a JMS queue, pulling information off of a JMS queue, publishing a topic, retrieving data from a topic, subscribing to a topic, sending email or transferring a file via file transfer protocol (FTP). The creation and manipulation of the JMS server and queues can be facilitated through interface module 28 administration screens. Interface module administration functions can use the application program interfaces (APIs) from individual JMS vendor's software. Thus, interface module 28 has the ability to serve as the nexus, or control center, for the interfaces for back-end systems by providing not only a simple method of manipulating multiple message servers, including JMS, but by also managing APIs for back-end system integration. In addition, interface module 28 also allows translation, routing and security using the GAAM addresses so that connected applications can access the local contract management module 22 installation, or “node”, without compromising control of the business objects and related corporate data.

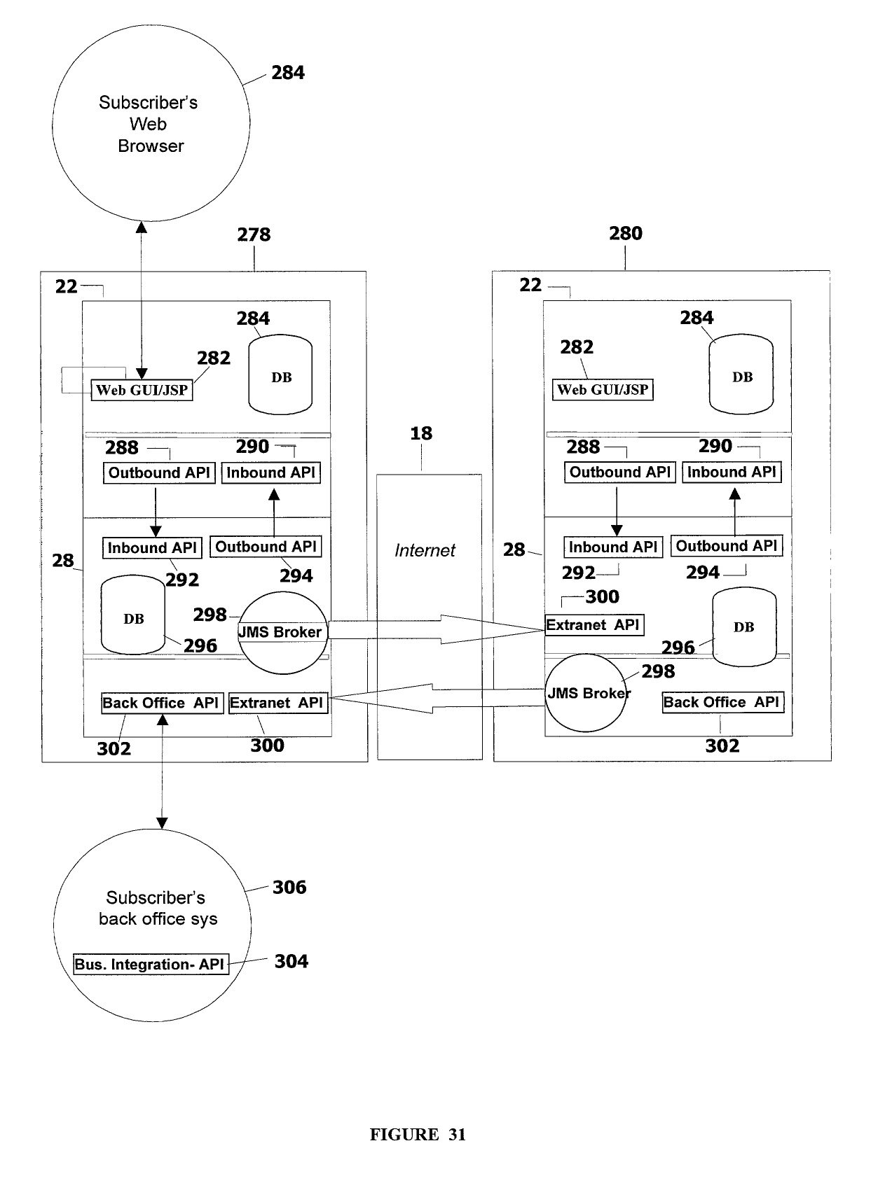

Interface module 28 facilitates business messages transformation, delivery and basic mapping functions between multiple contract management module 22 systems as depicted in FIG. 31. In that figure it can be seen that one organization's intranet 278 communicates with another organization's intranet 280 via the Internet 18. According to the invention, each intranet 278,280 includes a contract management module 22 and an interface module 28. Each contract management module includes a web GUI/JSP 282 which is capable of communicating with a subscriber's web browser 284 and a database 286 that stores transaction information and contract data. Contract management module 22 further includes an outbound API 288 and an inbound API 290 for communicating with an inbound API 292 and an outbound API 294, respectively, of interface module 28.

The interface module includes a database 296 containing Queue information that controls security, permissions, application addressing and identification. Each interface module 28 additionally includes a JMS broker 298 which communicates with an extranet API 300 of the other interface module through Internet 18. And, each interface module 28 includes a back office API 302 that communicates with a business API (Bi-API) 304 of a subscriber's back office system 306. So arranged, each organization or node in the network can visualize and collaborate on contract issues with other organizations in real-time while preserving the confidentiality of its own proprietary information.

FIG. 32 depicts the relational flow of graphical user interfaces of the contract management system according to the invention. The relational flow provides screens for the configuration and management of the interface module 28 queues and APIs. The interface module 28 allows for easy navigation through the software that drives the contract management system according to the invention. It can also independently serve as a portal to manage the integration with other software via specifically designed interfaces with commonly deployed software packages, as known as on-ramps and off-ramps.

As shown in FIG. 32, the system includes an administration screen 308 by which a system administrator may control and monitor the operation of the system. The administration screen is not accessible to the ordinary user. A main screen 310 includes menus that allow a user to browse two main pieces of information, marketplace information (MP info) and queues (Q). The marketplace information menu provides real-time access to data that is flowing inbound and outbound via the interface module 28 pipeline.

Two screens 312 and 314 flowing from the marketplace information portion of main screen 310 respectively provide data on partner information and a global marketplace list (MP list). View partner information screen 312 displays data on the trading partners that the organization is configured to do business with. View global marketplace list screen 314 shows information on all marketplaces that the instance system is set up to communicate with. From either screen 312,314 the user can navigate to the partner queue area (request queue) 316. This area allows the user to maintain queue information for the organization's various trading partners. From either of screens 312 and 316, the user may be transported to a manage partner MP ID 318 screen. Screen 318 permits the user to maintain partner queues and topics such as broadcast messages and cross organizational alerts. In addition to request screen 316, a user can navigate from screen 314 to an update my MP data screen 320 and a view detailed MP information screen 322. Screen 320 allows a user/subscriber to update its marketplace-related data and screen 322 view detailed information about its associated marketplace(s).

A third screen 320 flowing from main menu screen 310 (and also flowing from update my MP data screen 320) is identified herein as a manage user/subscriber MP ID screen 324. Screen 324 enables the user/subscriber to manage its marketplace IDs, which translate into JMS Server queues. This allows the present system to set up and maintain JMS Server communication that can be used to communicate with any other system or person who can support JMS technology. The user/subscriber can then list its outbound queues at screen 326, create new queues for its marketplace at screen 328, and view its inbound queue list at screen 330. Each item in the queue list (inbound and outbound) will drill down to a queue data page screen 332 and a topic data page 334. These pages provide the details of the queue (address, communication method, etc). And, each of screens 332 and 334 allow the user to navigate to manage partner MP ID screen in order to setup and maintain connection to other applications/MAS installations.

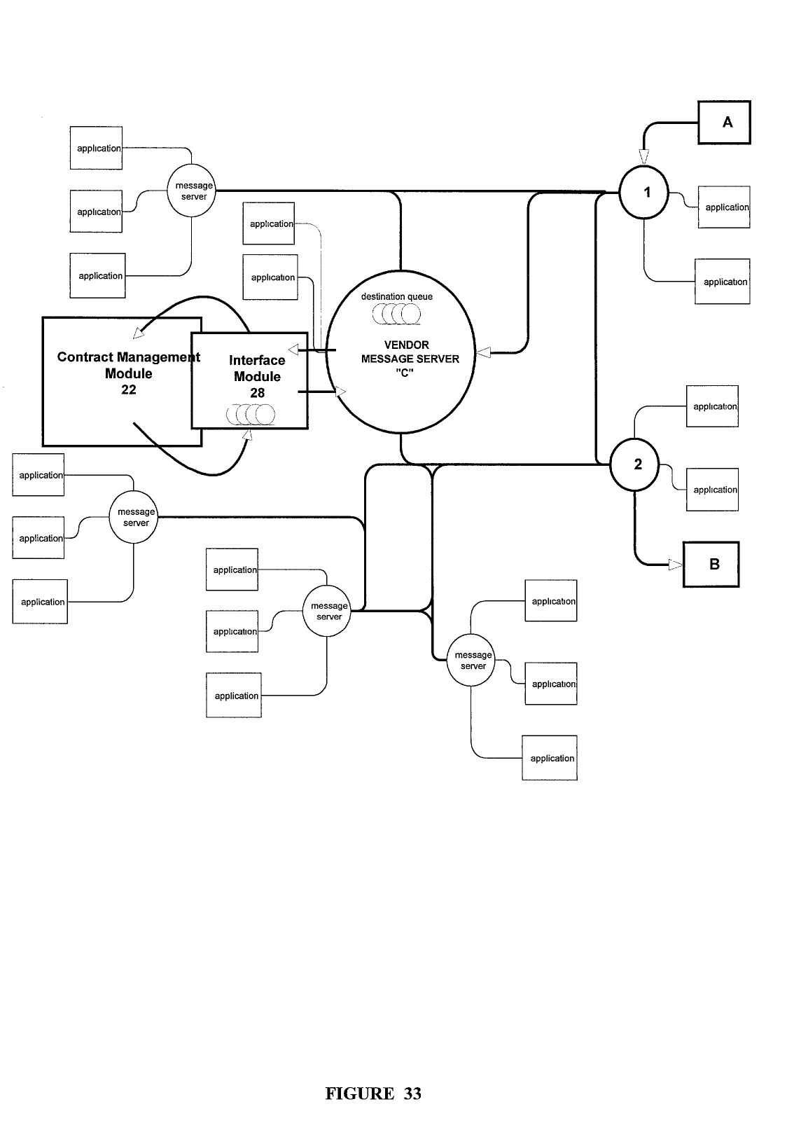

FIG. 33 depicts the manner in which the interface modules of nodes of an interactive network incorporating the contract management system according to the invention interact with one another using messaging services. A business object is addressed by its sender within the contract management module 22 module and sent directly to a queue on the interface module 28 network where one of the trading partners will be the recipient.

Contract management module 22 Application (“A”) sends a business object (e.g., a contract) based on an event (e.g., an approval) to its local message server within the local interface module 28/JMS application (“1”) Since the destination is pre-determined or determined by the user for that object/event, interface module 28 can scan its repository of contract management module 22 applications via marketplace identifiers to determine the destination queue.

Interface module 28/JMS application (“1”) consults its routing table and verifies that the destination queue on the receiving contract management module 22/interface module 28/JMS application (“C”) is an acceptable destination so it stores the message in its database (if requested to do so) then releases the sender contract management module 22 application. Interface module 28/JMS application (“1”) then forwards the message to the destination queue on the contract management module 22/interface module 28/JMS application The interface module 28 routing function is authorized to work directly on the contract management module 22/interface module 28/JMS application (“C”) monitors. It listens on the destination queue, selecting messages with attributes described in the message's metadata. Metadata is the system-defined messaging properties as well as special properties known to the trading partners embedded in the contract management module 22 business objects.

The interface module 28 routing function preserves the message content and intended services and determines from the business rule where to forward the message within the contract management module 22 application.

This process works in reverse for sending messages or, for instance, from the contract management module 22/interface module 28/JMS application (“C”) to the interface module 28 (“2”) to the Application (“B”). This sequence can be similar between non-contract management applications as well. However, in the event that a business object is passed that does not contain a valid GAAM address, the contract management application will queue the object for review by an user administrator in order to determine its relevance and properly address the object within the context of the contract management application.

As mentioned above in connection with FIG. 14, the present invention preferably incorporates the use of intelligent agents as part of its functionality. The intelligent agent technology according to the invention is highly reusable and easy to integrate within the context of the present system and its applications. Preferred implementations of the intelligent agents are the event processor and rule-based action/execution, user authoring of rule bases and basic support of inter-agent knowledge-level communication. The intelligent agents are object-oriented in design and are implemented in EJB. Features include portability within MAS applications and user-authored rule sets (including easy merging and updating), and dynamic generation of decision-based programs.

There are several operational categories of the intelligent agents. That is, they can be programmed to behave according to any of the following ans can be used as or in:

Learner—binary decision rules driven by a set of facts gathered by listening “devices” that represent the event;

Implementer—procedural elements that execute an action based on the results of the Learner, such as send information to a user (alert) or automating an approval (bot);

Networking—inter-agent communication (Agent Implementers feeding other Agent Learners) wherein this support scheme of exchanging rules and facts generally models a viral approach to the dissemination of information; and

Spawning—Users and Agents can “spawn” or create other agents and new rule sets. Hence, a user with little programming knowledge working with a GUI-based interface according to the invention can create an agent and associated rule sets as a way to direct the agent's behavior. Implementation of rule sets are also simpler to use than scripting-type programming languages and are more powerful than menus.

The benefits of intelligent agents is that they can act as electronic watchdogs that can automate monitoring tasks, thereby saving time and reducing costs for the human operator. Intelligent Agents perform the most repetitive or tedious tasks which allows buyers and sellers to devote their time and attention other more analytical tasks. As an example, a buyer may create an intelligent agent to automatically search for requirements associated with certain business objects, such as complex orders. When found, and based on certain pre-established criteria, the intelligent agent can attach a bill-of-materials for that requirement/option (bot) and/or notify the buyer (alert). Intelligent Agents can also monitor particular installations of the contract management system of the present invention (if so permitted), contracts or complex orders, and report on contracting trends, such as average cycle time, approval lag time or average number of issues created and resolved per contract. Through intelligent agents, an administrator of the present system can provide management reports and benchmarks without compromising security or revealing details of individual or company-specific transactions.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A system for generating a contract comprising:
a network;
a plurality of contract management modules including means for enabling contract creation, negotiation, collaboration, approval, analytics and storage; and
a plurality of interface modules in communication with said network and said contract management modules, said interface modules including means for enabling a plurality of users to communicate over said network and to create, negotiate, collaborate, approve, analyze and store a contract using said contract management modules.

2. The system of claim 1 wherein said network is the Internet.

3. The system of claim 1 wherein said plurality of contract management modules comprise at least three contract management modules and said plurality of interface modules comprise at least three interface modules whereby at least three parties can participate in generating a contract.

4. The system of claim 1 further comprising at least one additional interface module, said at least one additional interface module being in communication with said network and at least one electronic marketplace whereby users can communicate over said network with the at least one electronic marketplace during generation of a contract.

5. The system of claim 1 wherein said means for enabling contract creation, negotiation, collaboration, approval, analytics and storage comprise collaboration tools objects that are attachable to other objects generated during generation of a contract.

6. The system of claim 5 wherein said collaboration tools are selected from the group consisting essentially of issue items, action items, notes, and attachments.

7. The system of claim 1 wherein said interface modules further comprise means for restricting information a user chooses to communicate over said network.

8. The system of claim 1 said contract management modules further comprise means for determining the status of objects created during generation of a contract.

9. The system of claim 8 wherein said means for determining the status of objects created during generation of a contract comprise graphical user interface means.

10. The system of claim 1 further comprising intelligent agent means for automatically performing actions associated with generation of a contract.

11. Apparatus for use with a system operating over a network for generating a contract, said apparatus comprising:
a contract management module including means for enabling contract creation, negotiation, collaboration, approval, analytics and storage; and
an interface module communicable with the network and said contract management module, said interface module including means for enabling a user to communicate with at least one other user over the network and to create, negotiate, collaborate, approve, analyze and store a contract using said contract management module.

12. The apparatus of claim 11 wherein the network is the Internet.

13. The apparatus of claim 11 further comprising at least one additional interface module, said at least one additional interface module being in communication with the network and at least one electronic marketplace whereby a user can communicate over the network with the at least one electronic marketplace during generation of a contract.

14. The apparatus of claim 11 wherein said means for enabling contract creation, negotiation, collaboration, approval, analytics and storage comprise collaboration tools objects that are attachable to other objects generated during generation of a contract.

15. The apparatus of claim 14 wherein said collaboration tools are selected from the group consisting essentially of issue items, action items, notes, and attachments.

16. The apparatus of claim 11 wherein said interface module further comprises means for restricting information a user chooses to communicate over the network.

17. The apparatus of claim 11 said contract management module further comprises means for determining the status of objects created during generation of a contract.

18. The apparatus of claim 17 wherein said means for determining the status of objects created during generation of a contract comprise graphical user interface means.

19. The apparatus of claim 11 further comprising intelligent agent means for automatically performing actions associated with generation of a contract.

20. Apparatus for use with a system operating over a network for generating a contract, the system including means for enabling a user to communicate over the network, said apparatus comprising:
a contract management module including means for enabling contract creation, negotiation, collaboration, approval, analytics and storage, whereby a user can communicate with at least one other user over the network via the means for enabling a user to communicate with at least one other user to create, negotiate, collaborate, approve, analyze and store a contract using said contract management module.

21. The apparatus of claim 20 wherein the network is the Internet.

22. The apparatus of claim 20 wherein the system is in communication with at least one electronic marketplace whereby a user can communicate over the network with the at least one electronic marketplace during generation of a contract.

23. The apparatus of claim 20 wherein said means for enabling contract creation, negotiation, collaboration, approval, analytics and storage comprise collaboration tools objects that are attachable to other objects generated during generation of a contract.

24. The apparatus of claim 23 wherein said collaboration tools are selected from the group consisting essentially of issue items, action items, notes, and attachments.

25. The apparatus of claim 20 wherein said interface module further comprises means for restricting information a user chooses to communicate over the network.

26. The apparatus of claim 20 said contract management module further comprises means for determining the status of objects created during generation of a contract.

27. The apparatus of claim 26 wherein said means for determining the status of objects created during generation of a contract comprise graphical user interface means.

28. The apparatus of claim 20 further comprising intelligent agent means for automatically performing actions associated with generation of a contract.

29. A method of generating a contract comprising the steps of:
providing a network;
providing a plurality of contract management modules including means for enabling contract creation, negotiation, collaboration, approval, analytics and storage;
providing a plurality of interface modules in communication with the network and said contract management modules, said interface modules including means for enabling a plurality of users to communicate over the network; and
using said contract management modules to create, negotiate, collaborate, approve, analyze and store a contract over the network.

30. The method of claim 29 wherein the network is the Internet.

31. The system of claim 29 wherein said plurality of contract management modules comprise at least three contract management modules and said plurality of interface modules comprise at least three interface modules whereby at least three parties can participate in generating a contract.

32. The method of claim 29 further comprising providing at least one additional interface module, said at least one additional interface module being in communication with the network and at least one electronic marketplace whereby users can communicate over the network with the at least one electronic marketplace during generation of a contract.

33. The method of claim 29 wherein said means for enabling contract creation, negotiation, collaboration, approval, analytics and storage comprise collaboration tools objects that are attachable to other objects generated during generation of a contract.

34. The method of claim 33 wherein said collaboration tools are selected from the group consisting essentially of issue items, action items, notes, and attachments.

35. The method of claim 29 further comprising the step of providing means for restricting information a user chooses to communicate over the network.

36. The method of claim 29 further comprising the step of providing means for determining the status of objects created during generation of a contract.

37. The method of claim 36 wherein said means for determining the status of objects created during generation of a contract comprise graphical user interface means.

38. The method of claim 29 further comprising the step of providing intelligent agent means for automatically performing actions associated with generation of a contract.

39. A method of using a system operating over a network to generate a contract, said method comprising the steps of:
providing a contract management module including means for enabling contract creation, negotiation, collaboration, approval, analytics and storage; and
providing an interface module communicable with the network and said contract management module, said interface module including means for enabling a user to communicate over the network; and
using said contract management module to create, negotiate, collaborate, approve, analyze and store a contract over the network.

40. The method of claim 39 wherein the network is the Internet.

41. The method of claim 39 further comprising providing at least one additional interface module, said at least one additional interface module being in communication with the network and at least one electronic marketplace whereby a user can communicate over the network with the at least one electronic marketplace during generation of a contract.

42. The method of claim 39 wherein said means for enabling contract creation, negotiation, collaboration, approval, analytics and storage comprise collaboration tools objects that are attachable to other objects generated during generation of a contract.

43. The method of claim 42 wherein said collaboration tools are selected from the group consisting essentially of issue items, action items, notes, and attachments.

44. The method of claim 39 further comprising the step of providing means for restricting information a user chooses to communicate over the network.

45. The method of claim 39 further comprising the step of providing means for determining the status of objects created during generation of a contract.

46. The method of claim 45 wherein said means for determining the status of objects created during generation of a contract comprise graphical user interface means.

47. The method of claim 39 further comprising the step of providing intelligent agent means for automatically performing actions associated with generation of a contract.

48. A method of using a system operating over a network to generate a contract, the system including means for enabling a user to communicate over the network, said method comprising the steps of:
providing a contract management module in communication with the means for enabling a user to communicate over the network, said contract management module including means for enabling contract creation, negotiation, collaboration, approval, analytics and storage; and
using said contract management module to create, negotiate, collaborate, approve, analyze and store a contract over the network.

49. The method of claim 48 wherein the network is the Internet.

50. The method of claim 48 wherein the system is in communication with at least one electronic marketplace whereby a user can communicate over the network with the at least one electronic marketplace during generation of a contract.

51. The method of claim 48 wherein said means for enabling contract creation, negotiation, collaboration, approval, analytics and storage comprise collaboration tools objects that are attachable to other objects generated during generation of a contract.

52. The method of claim 51 wherein said collaboration tools are selected from the group consisting essentially of issue items, action items, notes, and attachments.

53. The method of claim 48 further comprising the step of providing means for restricting information a user chooses to communicate over the network.

54. The method of claim 48 further comprising the step of providing means for determining the status of objects created during generation of a contract.

55. The method of claim 54 wherein said means for determining the status of objects created during generation of a contract comprise graphical user interface means.

56. The method of claim 48 further comprising intelligent agent means for automatically performing actions associated with generation of a contract.

57. In a system for generating a contract operating over a network, the system including means for enabling a user to communicate over the network and a contract management module in communication with the means for enabling a user to communicate over the network, the contract management module including means for enabling contract creation, negotiation, collaboration, approval, analytics and storage, a method of assigning an application address to each business object created during generation of a contract, said method comprising the steps of:
assigning a marketplace identifier to each business object;
assigning a contract management module subscriber identifier to each business object;
assigning a contract management module user identifier to each business object;
assigning a business object type to each business object; and
assigning a business object identifier to each business object.
